(19) United States
(12) Patent Application Publication
(10) Pub. No.: US 2023/0303214 A1
(43) Pub. Date: Sep. 28, 2023

(54) ELECTRIC VEHICLE

(71) Applicant: Taiga Motors Inc., Lasalle (CA)

(72) Inventors: Shawn CONNORS, Bois-des-Filion (CA); Cyrus LARSEN, Montreal (CA); Daniel HALL, Montreal (CA); Christophe PETITCLERC-DEMERS, Montreal (CA); Samuel BRUNEAU, Montreal (CA)

(73) Assignee: Taiga Motors Inc., Lasalle (CA)

(21) Appl. No.: 18/103,024

(22) Filed: Jan. 30, 2023

Related U.S. Application Data
(60) Provisional application No. 63/309,773, filed on Feb. 14, 2022.

(51) Int. Cl. B62M 27/02; B60L 15/20

(52) U.S. Cl. CPC B62M 27/02; B60L 15/20; B60L 2260/16; B62K 2204/00

(57) ABSTRACT

An electric vehicle including an electric motor and a battery system to provide electrical power to the electric motor. A first input device, when actuated, provides a first input representing a command to propel the electric vehicle. A second input device, when actuated, provides a second input for initiating a boost operating mode. A controller is operative to control a permitted rate of change of a selected operating parameter of the electric motor. The controller, in a normal operating mode, operates the electric motor according to a first rate of change for the selected operating parameter in response to the first input, and in a boost operating mode, operates the electric motor according to a second rate of change, greater than the first, for the selected operating parameter for a limited period of time in response to the first input.

### CROSS-REFERENCE TO RELATED APPLICATION AND CLAIM OF PRIORITY

The present application claims priority to U.S. Provisional Pat. Application Serial No. 63/309,773 filed on Feb. 14, 2022, the entire contents of which are hereby incorporated by reference.

### FIELD OF THE INVENTION

This disclosure relates generally to electric vehicles (EVs) and, in particular, to electric powersport vehicles (EPVs).

### BACKGROUND

Due to their quiet, clean, and efficient powertrains, electric powersport vehicles (EPVs), such as snowmobiles, personal watercraft (PWC), and all-terrain vehicles (ATVs), for example, can be desirable to powersport enthusiasts. EPVs are often operated off-road in rugged terrain where power requirements may vary widely. In various circumstances, it can be can beneficial for an EPV to have the ability to be able to operate with increased power levels.

### SUMMARY

One example provides an electric vehicle including an electric motor to propel the electric vehicle, and a battery system to provide electrical power to the electric motor. A first input device, when actuated, provides a first input representing a command to propel the electric vehicle. A second input device, when actuated, provides a second input representing a power boost command. A controller is operative to control a permitted rate of change of a selected operating parameter of the electric motor to control propulsion of the electric vehicle. The controller, in a normal operating mode, operates the electric motor according to a first rate of change for the selected operating parameter in response to the first input, and in a boost operating mode, operates the electric motor according to a second rate of change for the selected operating parameter for a limited period of time in response to the first input. The second rate of change is greater than the first rate of change and the boost operating mode initiated upon actuation of the second input device.

One example provides an electric vehicle including an electric motor to propel the electric vehicle, and a battery system to provide electrical power to the electric motor. A first input device, when actuated, provides a first input representing a command to propel the electric vehicle. A second input device, when actuated, provides a second input representing a power boost command. A controller is operative to control a level of a selected operating parameter of the electric motor to control propulsion of the electric vehicle. The controller, in a normal operating mode, drives the selected operating parameter at a first level in response to the first input, and in a boost operating mode, drives the selected operating parameter, for a limited time period, at an increased level from the first level in response to the first input, the boost operating mode initiated upon actuation of the second input device.

One example provides a method of operating an electric vehicle. The method includes operating the electric vehicle in a normal operating mode including receiving a first input representing a command to propel the electric vehicle, and driving a selected operating parameter of the electric motor at first parameter level to propel the vehicle in response to a first input. The method further includes operating the electric vehicle in a boost operating mode for a limited time period in response to receipt of a second input representing a power boost command. The boost operating mode includes driving the selected operating parameter of the electric motor at an increased parameter level from the first parameter level to propel the electric vehicle. The method also includes returning to the normal operating mode upon expiration of the limited time period.

One example provides an electric vehicle including a battery system to provide electrical power to an electric motor to propel the vehicle, the battery system to normally provide electrical power up to a maximum continuous operating power level. A power boost system includes an input device, when actuated, to provide an input representative of a power boost command, and a controller. In response to actuation of the input device, the controller to cause the battery system to provide electrical power to the electric motor up to a boosted power level for a limited time period, wherein the boosted power level is greater than the maximum operating power level.

Additional and/or alternative features and aspects of examples of the present technology will become apparent from the following description, the accompanying drawings, and the appended claims.

### BRIEF DESCRIPTION OF THE DRAWINGS

FIG. 1A generally illustrates an electric vehicle, in particular, an electric snowmobile, including a power boost system, in accordance with one example of the present disclosure.

FIG. 1B is a perspective view illustrating an example of a braking system of the electric snowmobile of FIG. 1A.

FIG. 2 is a block and schematic diagram generally illustrating an electric vehicle, in particular, an electric snowmobile, including a power boost system, in accordance with one example of the present disclosure according to one example.

FIG. 3 is a graph illustrating an example of a mapping between a position of an accelerator and a selected operating parameter level at which an electric motor operates during a normal operating mode, according to one example of the present disclosure.

FIG. 4 is a graph illustrating an example of a mapping between a position of an accelerator and a selected operating parameter level at which an electric motor operates during a normal operating mode and a boost operating mode, in accordance with the present disclosure.

FIG. 5 is a graph illustrating an example of a mapping between a position of an accelerator and a selected operating parameter level at which an electric motor operates during a normal operating mode and a boost operating mode, in accordance with the present disclosure.

FIG. 6 is a graph illustrating an example of a power level at which an electric motor is operated in response to an accelerator position and a power boost operation, in accordance with the present disclosure.

FIGS. 7a, 7b and 7c are graphs illustrating examples of a mapping between a position of an accelerator and a selected operating parameter level at which an electric motor operates during a normal operating mode and a boost operating mode, in accordance with the present disclosure.

FIG. 8 is a graph illustrating an example of an operation of a variable resistance accelerator and a corresponding power level at which an electric motor is operated, according to one example of the present disclosure.

FIGS. 9a and 9b are flow diagrams generally illustrating methods of operating an electric vehicle including a power boost system, according to two examples of the present disclosure.

FIG. 10 is a flow diagram generally illustrating a method of operating an electric vehicle including a power boost system, according to one example of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Due to their quiet, clean, and efficient powertrains, electric powersport vehicles (EPVs), such as snowmobiles, personal watercraft (PWC), and all-terrain vehicles (ATVs), such as side-by-sides, for example, can be desirable to powersport enthusiasts. EPVs are often operated off-road in rugged terrain where power requirements may vary widely. In various circumstances, it can be beneficial for an EPV to have the ability to output additional or increased power. In some examples, additional or increased power may be desirable when requested by a rider (e.g. in an “on-demand” manner) when riding, via a physical or virtual user input or a voice command, among other possibilities. In some examples, additional or increased power may be desirable when the vehicle first starts moving in order to provide a type of “launch control”.

EPVs have electric powertrains typically including a battery system, comprising one or more battery modules, an electric motor with corresponding electronic motor drive (it is noted that multiple motors and drives may be employed), and various ancillary systems, such as thermal management systems, for example. EPVs can often be operated at “full throttle” for extended periods of time. Under such operating conditions, both the batteries and electric motor can generate large amounts of heat which can potentially be damaging to the batteries, motor, and other powertrain components. With this in mind, some EPV’s limit an amount of power provided to the electric motor by the battery system under “full throttle” conditions to a power level at which the motor and battery can be continuously operated without thermally damaging components of the electric power train (in particular, the battery system and electric motor). Such power level is sometimes referred to as the “maximum continuous operating power level”. In some cases, to ensure that the maximum continuous operating power level is not exceeded, an amount of current supplied by the battery system to the electronic controller/electric motor is limited. In other cases, the amount of power consumed by the electronic controller/electric motor is limited so as to limit a current draw from the battery system and not exceed the maximum continuous operating power level.

As described above, in some circumstances, it can be beneficial for EPVs to have the ability to operate at power levels which are beyond, or in excess of, the designed maximum continuous operating power level. For example, it may be beneficial for an electric snowmobile operating in deep snow or an ATV operating in mud or towing a load uphill to have the ability to access additional or increased power, at least temporarily.

EPVs may prevent an electric motor from exceeding a maximum continuous operating power level, which is a level at which the EPV may be operated indefinitely under “full throttle” conditions, in order to avoid thermal damage to the electric powertrain. Nevertheless, components of the electric powertrain, such as batteries and electric motors, for example, may be operated in excess of the maximum continuous operating power level for limited time periods without experiencing thermal damage. However, electric powertrains also have a peak operating power level which it is undesirable to exceed even for brief periods of time. Such operation may result in thermal and/or electrical damage to powertrain components.

As will be described in greater detail herein, according to examples, the present application discloses an EV and, in particular, an EPV, having a power boost system to enable the electric powertrain to selectively operate at increased or boosted operating power levels (sometimes called a boost power level) for limited time periods, including at operating power levels in excess of the maximum continuous operating power level, but not in excess of a peak operating power level. In examples, a maximum boosted operating power level may exceed the maximum continuous operating power level by a predefined percentage of the maximum continuous operating power level (e.g., 15%, 20%, etc.).

In examples, the increased operating power level is activated by an operator controlled actuation device, such as a push button, for example. In some examples, the increased operating power level is activated by voice command. In some examples, the limited time period during which the boosted operating power level is available may be a preset fixed time period (e.g., 10 seconds). In other examples, the boosted operating power level may be terminated prior to expiration of the limited time period (e.g. fixed predetermined time period) upon one or more operating parameter thresholds of the electric powertrain being exceeded (e.g., a maximum operating temperature or minimum operating voltage level of battery pack 22 being exceeded). In other examples, the limited time period may expire after a pre-defined boost energy budget has been exhausted. For example, the boost operating power level may provide an additional amount of energy, such as 0.5 to 2.5 kWh (kilowatt-hours), wherein the limited time period may last for as long as it takes for the electric vehicle to consume the boost energy budget. In other examples, the limited time period may expire after the earlier of a preset fixed time has elapsed, a pre-defined vehicle speed has been reached or an operating parameter threshold of the electric powertrain has been exceeded.

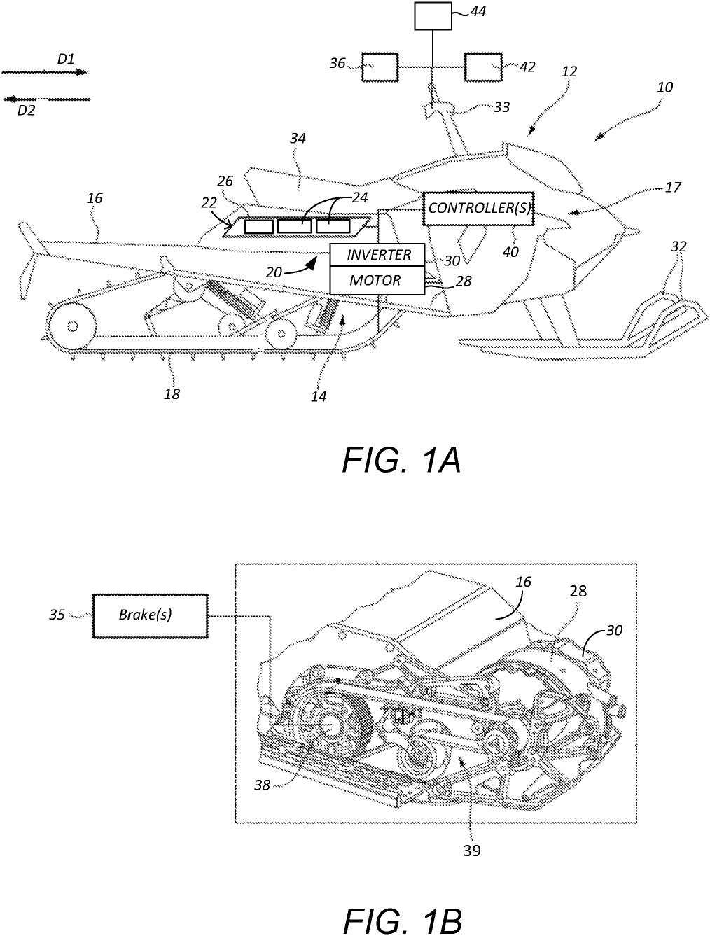

FIG. 1A is a block and schematic diagram generally illustrating an electric powersport vehicle 10, in this case a snowmobile, employing a power boost system 12, in accordance with examples of the present application. Although illustrated as a snowmobile, power boost system 12 may be employed in other types of electric vehicles such as electric UTVs (utility terrain vehicles) and other EPVs such as ATVs, personal watercraft (PWCs), and electric side-by-side vehicles, for example.

According to examples, electric snowmobile 10 includes a frame 14 (also known as a chassis) having a tunnel 16 and a forward portion 17, an endless drive track 18 for engaging the ground disposed below tunnel 14, and an electric powertrain 20. In examples, electric powertrain 20 includes a battery pack 22 having a number of rechargeable battery modules 24 and a battery management system (BMS) 26, and an electric motor 28 having a corresponding electronic motor controller 30 (also referred to herein simply as an “inverter) powered by battery pack 22. Although illustrated and described in terms of a single motor/inverter pair 28/30, in other examples, electric snowmobile 10 may include more than one motor/inverter pair 28/30.

Left and right skis 32 are moveably attached to forward frame portion 17 to permit steering of snowmobile 10 via a handlebar 33 interconnected with skis 32 (e.g., via a steering column). A straddle seat 34 is disposed above tunnel 14 for accommodating an operator and, optionally, one or more passengers (not shown). In some examples, the snowmobile 10 includes elements of a snow vehicle described in International Patent Application No. WO 2019/049109 A1 entitled “Battery Arrangement for Electric Snow Vehicles”, and US Pat. Application no 63/135,497 entitled “Electric Vehicle With Battery Pack as a Structural Element”, the entirety of which are incorporated herein by reference.

With further reference to FIG. 1B, snowmobile 10 includes one or more brakes 35 that may be applied or released by operator actuation of a break actuator 36 (e.g., a lever). In examples, brake 35 may be operable as a main brake for slowing and stopping electric snowmobile 10 during operation. Alternatively, or in addition, brake 35 may be operable as a parking brake, sometimes called an “e-brake” or “emergency brake” to be used when electric snowmobile 10 is stationary. In examples, such main and parking brake functions may use separate or common breaks 35. In some examples, brake actuator 36 may be lockable when applied in order to employ brake 35 as a parking break. In examples, brake 35 may be electrically or hydraulically operated. For example, brake 35 may include a master cylinder operatively connected to a brake caliper that urges brake pads against a brake rotor or disk that is coupled to powertrain 20. In some examples, such brake rotor may be secured to and rotatable with a drive shaft 38 driving endless drive track 18.

Actuation of brake actuator 36 make cause a combination of tractive braking and regenerative braking. In some embodiments, the braking may be implemented as described in US Pat. Application No. 17/091,712 entitled “Braking System For An Off-Road Vehicle”, the entirety of which is incorporated herein by reference. Is some embodiments, regenerative braking may be used such that battery 22 is supplied with electrical energy generated by motor 28 operating as a generator when brake actuator 36 is applied, an/or when the operator releases a first input device 42 (e.g., accelerator 42).

In examples, electric motor 28 is drivingly coupled to endless drive track 18 via drive shaft 38. In one example, electric motor 28 is in a torque-transmitting engagement with drive shaft 38 via a belt/pulley drive 39 such that torque produced by electric motor 28 drives endless track 40 to propel electric snowmobile 10.. It is noted that motor 28 may be in torque-transmitting engagement with drive shaft 38 via other arrangements such as a chain/sprocket drive, or a shaft/gear drive, for example. In examples, drive shaft 38 may be coupled to track 18 via one or more toothed wheels or other means to transmit motive power from motor 28 to track 18.

In examples, rechargeable battery modules 24 of battery pack 22 each include a number of battery cells which are interconnected with one another in parallel and series combinations to provide a high voltage (HV) output, such as in the range of 300-400 VDC, and in some cases up to 800 VDC, for example. In some embodiments, the battery modules 24 may include a lithium ion or other suitable battery cell types. In examples, BMS 26 monitors and regulates a number of operating parameters of battery pack 18, such as voltage level and temperature levels of battery modules 24 and/or individual battery cells thereof, for example.

Electronic controller (inverter) 30 converts DC power received from battery pack 22 to AC power to drive electric motor 28. In examples, electric motor 28 has a power output of between 120 and 180 horsepower. In other examples, electric motor 28 has a maximum output power of greater than 180 horsepower.

In examples, the operation of electric motor 28 and the delivery of drive current to electric motor 28 from battery pack 22 and inverter 30 is controlled by a controller 40. In examples, controller 40 is operable to control the delivery of electrical power from battery pack 22 to electric motor 28/inverter 30 via control of a drive current as a function of one or more input signals from one or more input devices, such as a first input device 42 which provides a first input or first signal indicative of a command to propel electric snowmobile 10 (i.e., to drive electric motor 28 to drive track 18). In one example, first input device 42 is an operator-actuated accelerator 42, also referred to as a “throttle” 42. In examples, as will be described in greater detail below, controller 40 is operable to control levels of one or more selected operating parameters of electric motor 28, such as an output torque or rotational speed (rpm) of electric motor 28, in response to the first input from accelerator 42 to control the propulsion of electric snowmobile 10.

In one example, each position of the accelerator 42 is mapped to a desired level at which to operate the selected operating parameter of the electric motor 28. A relationship exists between a position of the accelerator 42 and a requested level of an operating parameter at which to operate motor 28 (e.g. Nm or rpm). In one example, as the accelerator 42 is actuated, controller 40 reads the position of the accelerator 42 at a given frequency (e.g. 1 KHz) and requests the motor to achieve the level of operating parameter associated with the detected accelerator 42 position. However, the controller 40 may also control the rate of change (e.g. Nm/ms or rpm/ms), often referred to as the ramp rate, for the selected operating parameter. As such, if the accelerator 42 is actuated very quickly, the controller 40 may limit the time it takes to achieve the requested level of operating parameter associated with the accelerator position based on a permitted ramp rate. For example, if an operator of the vehicle actuates the accelerator 42 from a 0% position to a 100% position very quickly, it is possible that the permitted ramp rate will cause the motor 28 to take longer to achieve 100% of the requested operating parameter than it took the accelerator 42 to move to 100% of its actuation range. In other words, there may be a lag between the accelerator 42 achieving a given position within its actuation range and the motor achieving the requested level of operating parameter (e.g. Nm or rpm) associated with that accelerator position. The ramp rate at which the operational parameter is increased/decreased is generally selected based on a combination of rider “feel”, energy draw from the battery and ease of motor control.

The rate of change of the selected operating parameter may be linear in relation to the actuation range of the accelerator 42. Alternatively, the rate of change of the selected operating parameter may be non-linear in relation to the actuation range of the accelerator 42. For example, the rate of change of the selected operating parameter may change exponentially, logarithmically or in any other non-linear fashion over the actuation range of the accelerator 42.

In examples, throttle 42 may be located on handlebar 33 or at other suitable locations (e.g., a footrest). A direction of rotation of electric motor 28 may be selected with throttle 42, or via a separate input device (not shown) in order to propel the snowmobile 10 in a selected one of a forward direction D1 and a rearward direction D2. In examples, controller 40 and throttle 42, along with any number of other input devices (e.g., torque sensors, rotational speed sensors, temperature sensors, load sensors, gyroscopes), are part of a control system CS for controlling operation of electric snowmobile 10.

In examples, as will be described in greater detail below, in a normal operating mode, controller 40 drives the selected operating parameter at a first level in response to the first input from throttle 42. In one example, a maximum value of the first level of the selected operating parameter corresponds to motor 28 operating at a predefined maximum operating power level. In one example, the predefined maximum operating power level is the maximum continuous operating power level. In other examples, the predefined maximum operating power level is a manufacturer-defined or user-defined maximum operating power level for the specific vehicle, the specific vehicle model and/or the specific operating mode in which the vehicle is operating (e.g. Eco, Normal and Sport mode, among other possibilities). For example, the predefined maximum operating power level may be lower in Eco mode than in Sport mode. The manufacturer-defined or user-defined maximum operating power level may be a maximum continuous operating power level for the vehicle, or it may be an operating power level that is below the maximum continuous operating power level for the vehicle.

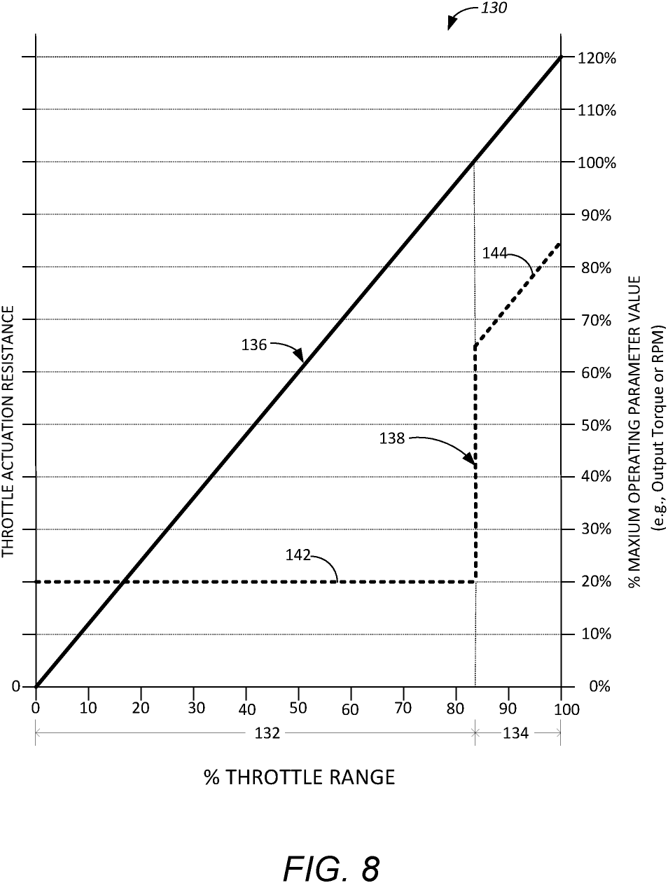

In examples, as will also be described in greater detail below, power boost system 12 includes a second input device 44 that, when actuated by an operator, provides a second input or second signal (such as to controller 40) indicative of a power boost command to initiate a temporary boost operating mode. According to examples, upon actuation of the second input device, the controller drives the selected operating parameter in the boost operating mode for a limited time period. More particularly, in the boost operating mode the controller 40 drives the selected operating parameter at an increased level from the first level in response to the first input. In the boost operating mode, the controller 40 may enable the electric motor 28 to operate at power levels in excess of the continuous maximum operating power level, including up to a maximum boosted operating power level. In the boost operating mode, the selected operating parameter is operated at an increased level from the first level in response to the first input from throttle 42 (a so-called “boosted level”), with a maximum boosted operating power level of the selected operating parameter corresponding to motor 28 operating at the maximum boosted operating power level. In one example, second input device 44 is a push-button. The push-button may include one or more physical (hard) buttons and/or one or more graphical objects (soft buttons) on a display screen of a graphical operator interface, for example. In another example, the second input device 44 may be a voice receiver to receive a voice command. In other examples, as will be described in greater detail below (e.g., see FIG. 8 and the associated description), first and second input devices 42 and 44 may be part of a single input device. In some examples, power boost system 12 represents a portion of control system CS for controlling operation of electric snowmobile 10.

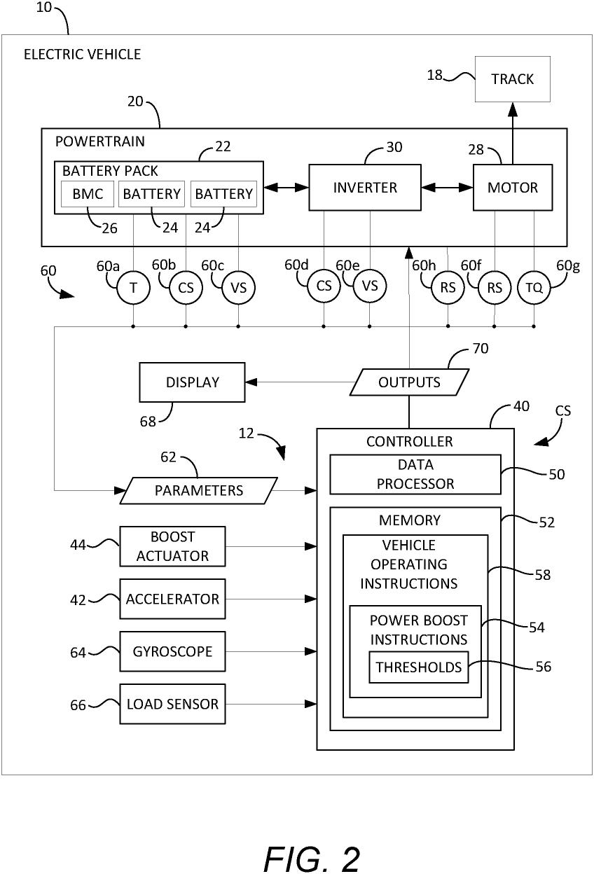

FIG. 2 is a block and schematic diagram generally illustrating an example of a power boost system 12, in accordance with the present disclosure, for use with electric vehicles, such as EPVs, including electric snowmobile 10. Although illustrated and described in relation to electric snowmobile 10, power boost system 12 may be employed with any suitable EV and any suitable off-road electric vehicle. In one example, power boost system 12 includes one or more inputs, such as accelerator 42 (also sometimes referred to as accelerator actuator 42 and throttle 42) and boost actuator 44, one or more data processors, such as data processor 50, and non-transitory machine-readable memory 52 storing machine-readable instructions, such as power boost instructions 54 (including operational thresholds 56), executable by processor 50 to perform and carry out power boost operations, in accordance with the present disclosure, and which will be described in greater detail below. In examples, power boost system 12 receives operating parameters 62 from a number of sensors 60 sensing one or more operating parameters of electric powertrain 20, such as temperature sensor 60a, current sensor 60b, and voltage sensor 60c corresponding to battery pack 22, current sensor 60d and voltage sensor 60e corresponding to inverter 30, rotational speed sensor 60f and output torque sensor 60 g corresponding to motor 28, and coolant temperature sensor 60h.

In examples, as illustrated, data processor 50 and memory 52 may be part of controller 40 which, as described above, forms part of control system, CS. In examples, accelerator 42 and sensors 60 are included as part of control system, CS, with power boost system 12 operable to receive inputs and sensed operating parameters 62 therefrom. Controller 40 may be operatively connected (e.g., via wired or wireless connections) to a number of input devices, including accelerator 42 and boost actuator 44, and to a number of sensors, including sensors 60, with received inputs and sensed operating parameters 62 used by controller 40 to control operation of electric snowmobile 10, such as via execution by processor 50 of instructions stored in memory 52, such as vehicle operating instructions 58. In examples, as illustrated, power boost system 12 forms a portion of control system, CS, with power boost instructions 54 representing a portion of vehicle operating instructions 58. In examples, control system, CS, may include additional devices such as a gyroscope 64 (for sensing an orientation (e.g., incline/decline) of electric snowmobile 10) and a load sensor 66 (e.g., for sensing a load carried by electric snowmobile 10) which provide inputs and sensed parameters to controller 40, and controller 40 may provide outputs to one or more output devices, such as a display device 68.

Controller 40 may carry out functions in addition to those described herein. Processor 50 may include any suitable device(s) to cause a series of steps to be performed by controller 40 to implement a computer-implemented process such that power boost instructions 54, together with vehicle operating instructions 58, when executed by controller 40, or other programmable apparatus, carry out method(s) described herein. Processor 50 may include, for example, any type of general purpose microprocessor or microcontroller, a digital signal processing (DSP) processor, an integrated circuit, field programmable array (FPGA), a reconfigurable processor, other suitably programmed or programmable logic circuits, or any combination thereof.

Memory 52 may include any suitable machine-readable storage medium, including non-transitory computer readable storage medium such, but not limited to, for example, to an electronic, magnetic, optical, electromagnetic, infrared, or semiconductor system, apparatus, or device, or any suitable combination thereof. Memory 52 may include a suitable combination of any type of machine-readable memory that is located either internally or externally to controller 40. Memory 52 may include any storage means (e.g., devices) suitable for retrievably storing machine-readable instructions executable by processor 50, including power boost instructions 54 and vehicle operating instructions 58.

Various aspects of the present disclosure may be embodied as systems, devices, methods, and/or computer program products. Accordingly, aspects of the present disclosure may take the form of an entirely hardware embodiment, an entirely software embodiment, or an embodiment combining software and hardware aspects. Furthermore, aspects of the present disclosure may take the form of a computer program product embodied in one or more non-transitory computer readable medium(ia) (e.g., memory 52) having computer readable program code (e.g., instructions 50) embodied thereon. Computer program code for carrying out operations for aspects of the present disclosure in accordance with power boost instructions 54, as well as vehicle operating instructions 58, may be written in any programming language or combination of programming languages. Such program code may be executed entirely or in part by controller 40 or other data processing device(s). It is understood that, based on the present disclosure, one skilled in the art could write computer code for implementing the methods described and illustrated herein.

In operation, in accordance with vehicle operating instructions 58, and based at least on inputs from accelerator 42, parameters 62 from one or more sensors 60, and inputs from power boost system 12 (including boost actuator 44), controller 40 provides outputs 70 to powertrain 20 to control delivery of DC electric power from battery pack 22 to inverter 30, and to control delivery of an AC waveform from inverter 30 to control operation of electric motor 28. In examples, in response to actuation of accelerator 42, and specifically based on a position of accelerator 42 (and, in some cases, in further response to actuation of boost actuator 44, as will be described in greater detail below), controller 40 adjusts characteristics of the AC waveform (e.g., frequency and amplitude of voltage and current waveforms) delivered to motor 28 by inverter 30 to control levels of one or more selected operating parameters of motor 28 (such as a rotational speed (rpm) and/or an output torque, for example) to implement a desired response and expected performance of electric motor 28. In some cases, in addition to accelerator 42 (and, in some cases, boost actuator 44), controller 40 may implement a desired response of electric motor 28 based on additional inputs, such as on parameters 62 (e.g., a measured rotational speed of motor 28 as provided by rotational speed sensor 60f, and a measured output torque of motor 28 as provided by torque sensor 60 g) and further inputs, such as from gyroscope 64 and load sensor 66, which together provide indication of operating conditions of electric snowmobile 10.

The amount of electrical power delivered from battery pack 22 to electric motor 28/inverter 30 depends on the levels of the one or more selected operating parameters at which electric motor is directed to operate by controller 40 (e.g., the greater the output torque provided, the greater the electrical power required). As described above, to prevent potential thermal damage to components of electric powertrain 20, during operation, controller 40 limits an operating power level of electric motor 28 to a power level at which motor 28 can continuously operate, referred to herein as the maximum continuous operating power level. As such, in normal operating mode (i.e., when boost actuator 44 has not been actuated, as will be described in greater detail below), maximum levels at which the one or more selected operating parameters are directed to operate by controller 40 are dictated (or limited) by the maximum continuous operating power level of electric motor 28.

In some cases controller 40 may control operation of electric motor 28 so as to limit the electrical power delivered to electric motor 28 to a maximum continuous operating power level of 120 HP (or equivalent kW). In other cases, controller 40 may control the maximum continuous operating power level of electric motor 28 to a level of 180 HP (or equivalent kW). In examples, a maximum continuous operating power level to which controller 40 controls operation of electric motor 28 may be any suitable power level at which electric powertrain 20 can continuously operate without causing thermal damage to components thereof, and may vary based on the particular arrangement, configuration, and ratings of component of powertrain 20. In some examples, to limit the power level at which motor 28 operates, controller 40 may control an amount of drive current provided by battery pack 22 to inverter 30 and, in other examples, may control the AC output waveform provided by inverter 30.

In examples, as described above, during operation, controller 40 operates motor 28 based on an input signal from accelerator 42 (sometimes referred to herein as the first input device). In some examples, accelerator 42 may be actuated over a range of travel (an actuation range), where a position of the accelerator within the actuation range is mapped by controller 40 to a level of the selected controllable operating parameter (e.g., output torque, rpm) at which to operate motor 28. In one example, a low end of the actuation range may correspond to an operating level of “zero” and a high end of the actuation range may correspond to a maximum level of the selected controllable operating parameter (e.g., maximum output torque and maximum rpm), which, during normal operating mode, is limited by the maximum continuous operating power level of electric motor 28 (e.g., 120 HP). For a given maximum continuous operating power level of electric motor 28, it is noted that a maximum level of the selected operating parameter may be different under different conditions. For example, in a case where the selected operating parameter is the rotational speed (rpm) of electric motor 28, the maximum rpm may be greater when electric snowmobile 10 is traveling downhill than when traveling uphill, as less power is required to achieve a given rpm when traveling downhill.

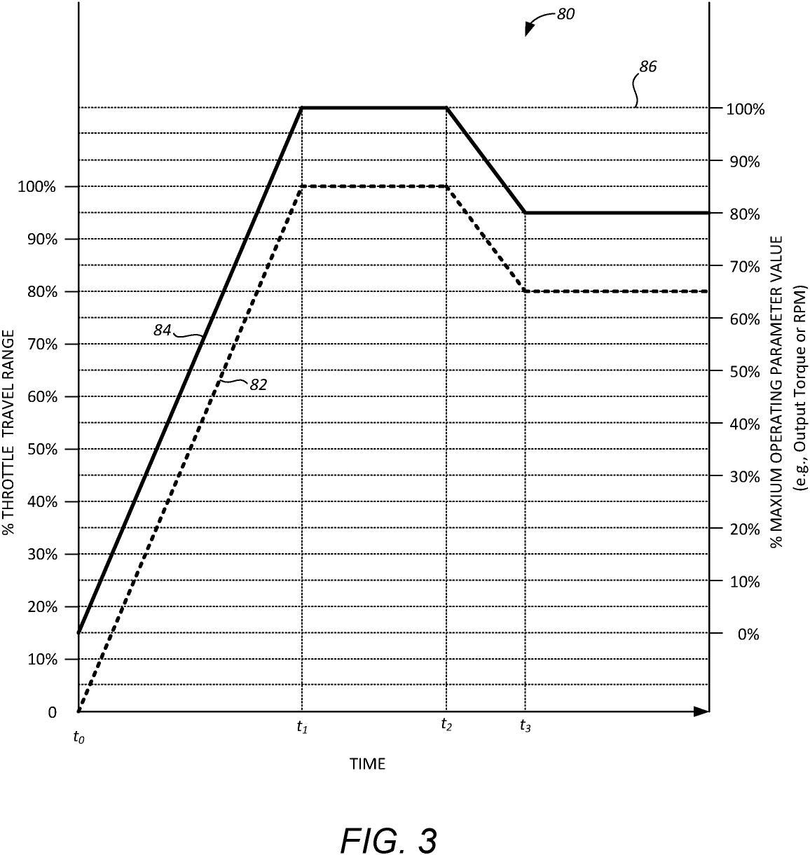

FIG. 3 is a graph 80 illustrating an example of a mapping between a position of accelerator actuator 42 over a range of travel (e.g., a throttle lever moveable over an actuation range, a throttle handle rotatable over a range of travel) and a corresponding level at which to operate the selected operating parameter of electric motor 28 (referred to herein as a “requested level”) during a normal operating mode of power boost system 12. In graph 80, time is illustrated on the x-axis, a percentage of an actuation range of throttle 342 is indicated along a y-axis on the left-side of graph 80, and a percentage of a maximum level of the selected operating parameter of electric motor 28 is indicated along a y-axis on the right-side of graph 80. In examples, the maximum requested level of the selected operating parameter (i.e., indicated as 100% of the maximum operating parameter level) may be a predefined value for the electric vehicle, in this case, electric snowmobile 10, where the predefined value may be different for different vehicles. Throttle position as a percentage of the actuation range is illustrated by curve 82, and a level of the selected operating parameter of electric motor 28 is illustrated by curve 84.

In examples, the selected operating parameter represented by curve 82 may be one of any number of controllable operating parameters. For example, in one case, the selected operating parameter represented by curve 84 may be an output torque (Nm) of electric motor 28. In another case, the selected operating parameter represented by curve 84 may be a rotational speed (rpm) of electric motor 28. In the illustrated example, a relationship between a position of throttle 42 and a percentage of the maximum selected operating parameter level at which motor 28 is controlled to operate is linear over the actuation range of throttle 42, with the selected operating parameter level of motor 28 having a value of “0” with throttle 42 at 0% of its actuation range, and having a value of 100% of the maximum operating parameter value with throttle 42 actuated to 100% of its actuation range, so long as operating at 100% of the maximum operating parameter value does not require electric motor 28 to operate in excess of the predefined maximum continuous operating power level. In examples, should the requested level of the selected operating parameter require electric motor 28 to operate above the predefined maximum continuous operating power level (e.g., due to environmental operating conditions of electric snowmobile 10, such as traveling uphill in deep snow), the maximum level of the selected operating parameter at which electric motor 28 will be operated will be capped at a greatest level possible (e.g., less than the predefined maximum operating parameter level) without electric motor 28 operating beyond the maximum continuous operating power level. Although illustrated in FIG. 3 as being a linear relationship or mapping between a position of throttle 42 and a requested level at which to operate the selected operating parameter of motor 28, in other examples, the relationship may be non-linear.

In FIG. 3, at time t₀, throttle 42 is at 0% of its travel range, such that the selected operating parameter of motor 28 is at a “zero” value (e.g., “zero” output torque and/or zero rotational speed). Between time t₀ and t₁, an operator actuates throttle 42 from 0% to 100% of its travel range such that the selected operating parameter of motor 28 is operating at 100% of the maximum operating parameter value at time t₁. In FIG. 3, it is assumed that a permitted ramp rate will facilitate a real-time correspondence between the throttle position (curve 82) and an associated level of operating parameter (curve 84) achievable by the motor 28. Between time t₁ and t₂, throttle 42 is maintained at 100% of its travel range such that the selected operating parameter of motor 28 is operating at 100% of the maximum operating parameter value (or at the highest operating parameter value possible without requiring motor 28 to exceed a predefined maximum operating power level, which may be the maximum continuous operating power level, a manufacturer-defined maximum operating power level, or other maximum operating power level). Between time t₂ and time t₃, a position of throttle 42 is adjusted from 100% to 80% of its travel range, such controller 40 decreases the selected operating parameter of motor 28 from 100% to 80% of the maximum operating parameter value. After time t₃, a position of throttle 42 is maintained 80% of its travel range such that the selected operating parameter of motor 28 is maintained at 80% of the maximum operating parameter level.

As described above, a maximum level of the selected operating parameter of electric motor 28 controlled by controller 40 may be set at a predefined maximum operating parameter level, but due to operating conditions or other circumstances, may be capped to values less than the predefined maximum operating parameter level. As an illustrative example, a maximum level of output torque of electric motor 28 may be predefined as 170 Nm. When traveling on a flat surface, motor 28 may achieve 170 Nm at an operating power not exceeding the predefined maximum operating parameter level. However, when traveling uphill, for example, to achieve an output torque of 170 Nm, electric motor 28 may require electrical power in excess of the predefined maximum operating power level, including in excess of the maximum continuous operating power level. As such, according to the illustrative example, when traveling uphill, the output torque level of electric motor 28 may be controlled to achieve only a level of 160 Nm based on one or more of the predefined maximum operating power level or the maximum continuous operating power level.

As described above, it can be beneficial for EVs, and for EPVs in particular, to have the ability to operate the electric motor(s), such as electric motor 28 of electric snowmobile 10, at power levels which are beyond, or exceed, a predefined maximum operating power level, including the maximum continuous operating power level. For example, it may be beneficial for an electric snowmobile operating in deep snow or an ATV operating in mud or towing a load uphill to have the ability to access increased power, at least temporarily. Having access to power levels which are beyond, or exceed, a predefined maximum operating power level may also be desirable when starting from a resting position. For example, if starting an electric snowmobile when in deep snow, it may be desirable to initiate a boost operating mode at the time of launch (e.g. upon actuation of the accelerator 42) to achieve an increased launch power that is sufficient to escape the deep snow from a resting position.

As further described above, according to examples of the present disclosure, during operation of electric snowmobile 10, in response to operator-actuation of boost actuator 44 (e.g., pushing a power boost button), power boost system 12 initiates a boost operating mode where controller 40, such as via execution of power boost instructions 54 by processor 50, enables electric powertrain 22 to temporarily operate motor 28 at an increased (or “boosted”) operating power level, including at power levels in excess of the maximum continuous operating power level (sometimes referred to herein as a power boost operation). As will be explained below, in examples, the increased operating power level may be power required to operate electric motor 28 at a percentage increase of a maximum value of a selected operating parameter corresponding to a position of throttle 42 according to a second mapping (sometimes referred to as a boost mapping) which is different from a first mapping during normal operating mode (sometimes referred to as a normal or base mapping), such as illustrated by the example of FIG. 3.

In addition to employing a different mapping during boost operating mode than during normal operating mode, controller 40 may temporarily increase a maximum power level at which electric motor 28 may be operated from a predefined maximum operating power level, including a maximum continuous operating power level, to a maximum boosted operating power level. In examples, the maximum boosted operating power level may exceed the predefined maximum operating power level or maximum continuous operating power level by a percentage of that power level(say 10%, 15%, 20%, and even 50%, for example). For instance, as an illustrative example, if a maximum continuous operating power level of motor 28 is 120 HP (or equivalent kW) and a boosted operating power level exceeds the maximum continuous operating power level by 20%, the maximum boosted operating power level would be 144 HP (or equivalent kW).

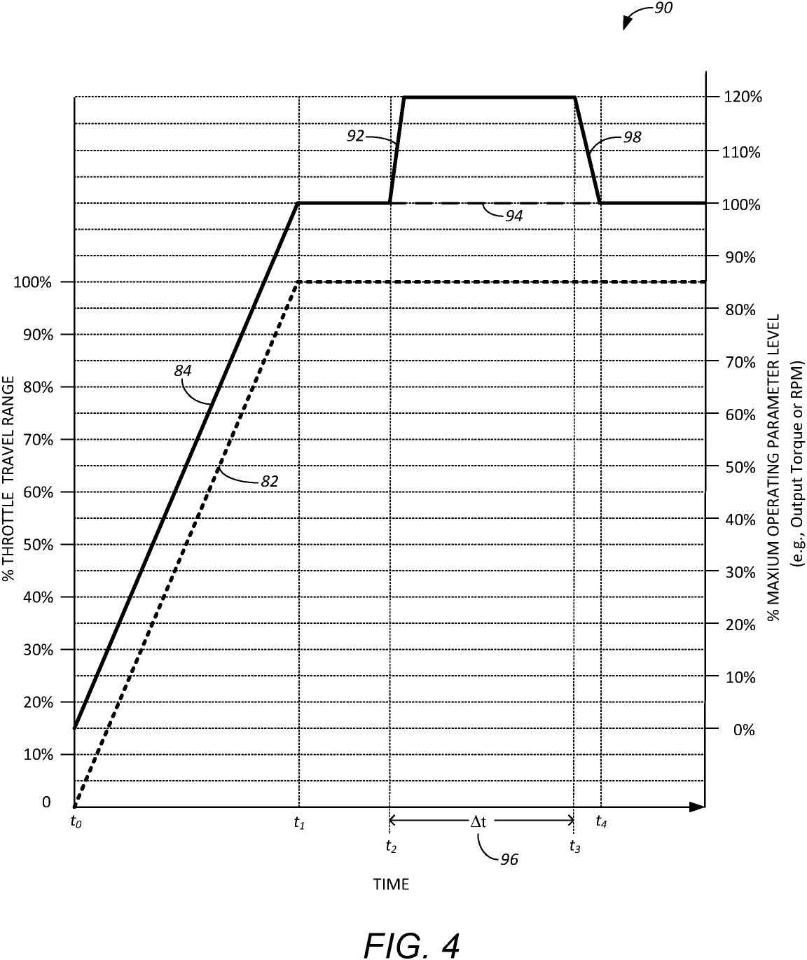

In some examples, the boost operating mode may be initiated (e.g., via actuation of boost actuator 44) only when motor 28 is operating at the predefined maximum operating power level (which may be the maximum continuous operating power level) (e.g., see FIG. 4), that is, when throttle 42 is fully actuated (i.e., at 100% of its actuation range). In other examples, such as in a launch control application, the boost operating mode may be initiated when motor 28 is operating at a power level less than the predefined maximum operating power level, including when the throttle 42 is at 0% of its actuation range. In such an example, the boost actuator 44 may be actuated before initiating movement of the vehicle. When the throttle 42 is actuated, the power level at which motor 28 can operate may be increased from the predefined maximum operating power level (which may be the maximum continuous operating power level) to the maximum boosted operating power level. Alternatively, or additionally, a ramp rate at which the operating parameter is controlled may be increased. Alternatively, or additionally, a mapping between the position of throttle 42 and a requested level of the operating parameter may be adjusted from a normal or base mapping (the first mapping) to a boost mapping (the second mapping).

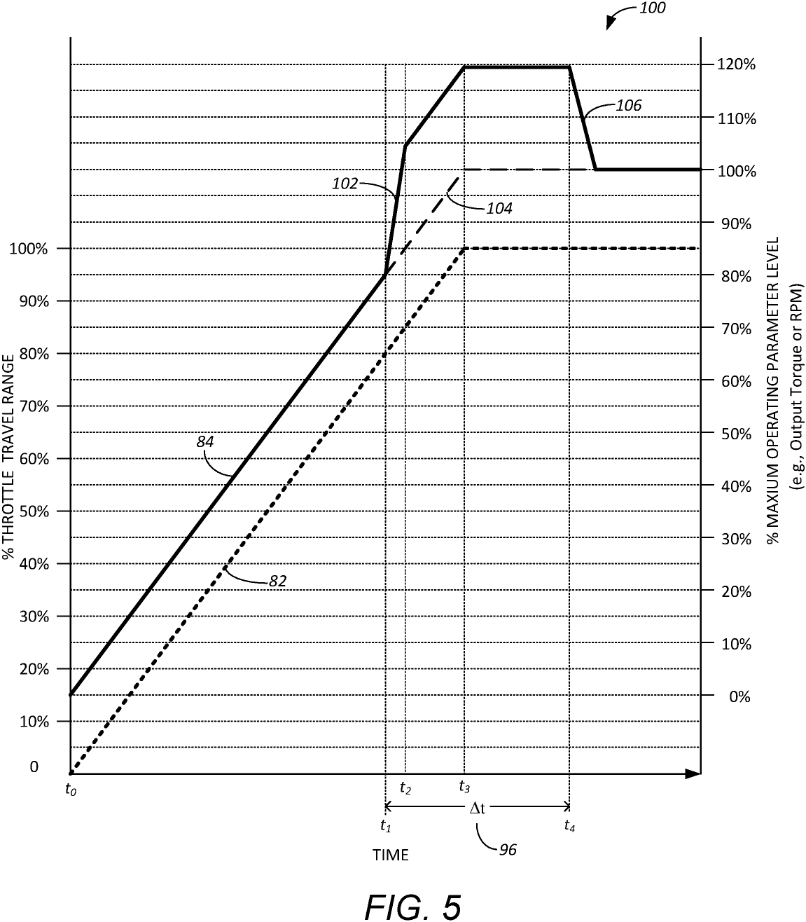

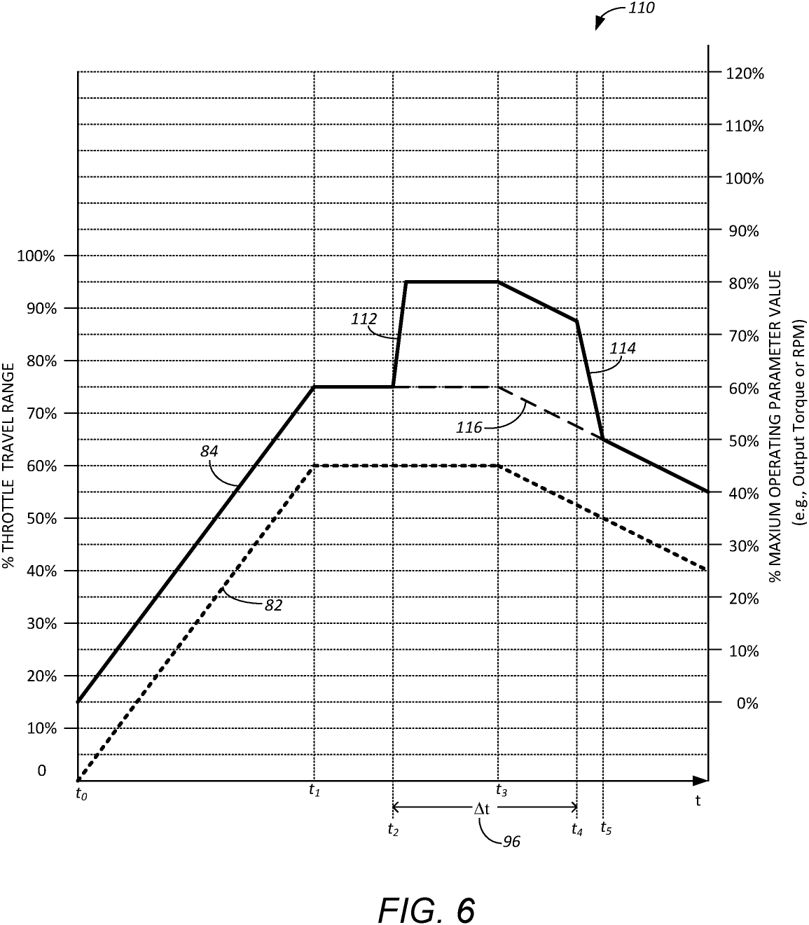

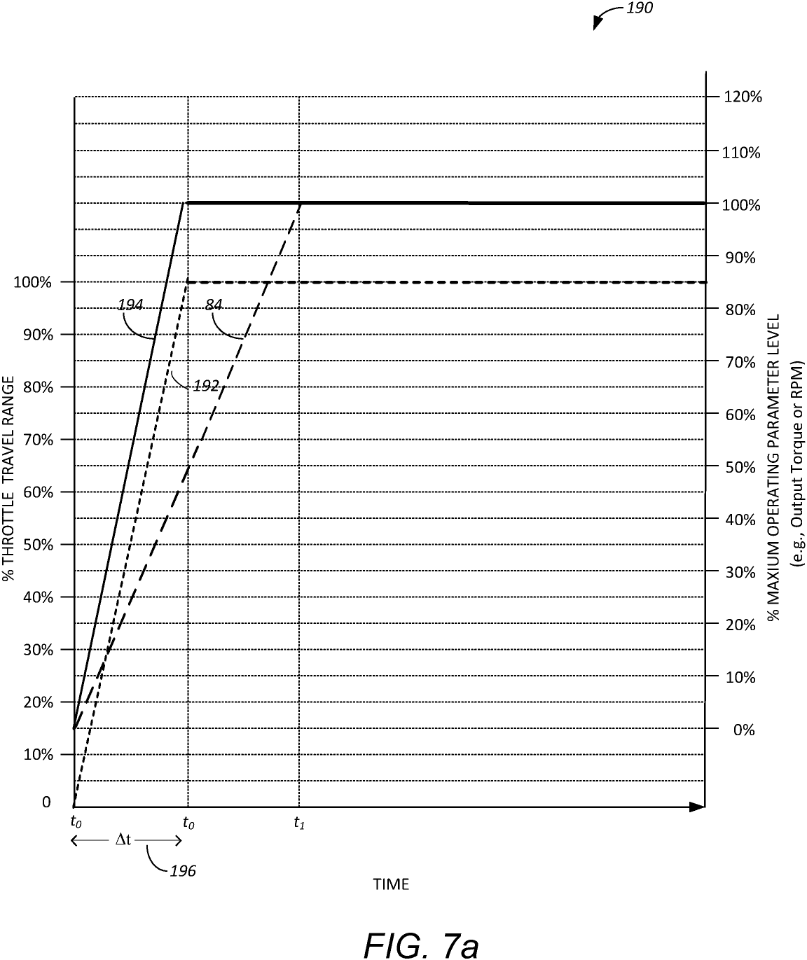

In other examples, the boost operating mode may be initiated when motor 28 is operating at power levels between 0%-100%. That is, when throttle 42 is less than fully actuated (e.g., see FIGS. 5 and 6), such that upon actuation of boost actuator 44 (e.g., when a boost power button is pressed by an operator) the power level at which motor 28 is operated is increased from the predefined maximum operating power level, which may be the maximum continuous operating power level, to the maximum boosted operating power level, and a mapping between the position of throttle 42 and a requested operating parameter level is adjusted from the normal or base mapping (the first mapping) to the boost mapping (the second mapping).

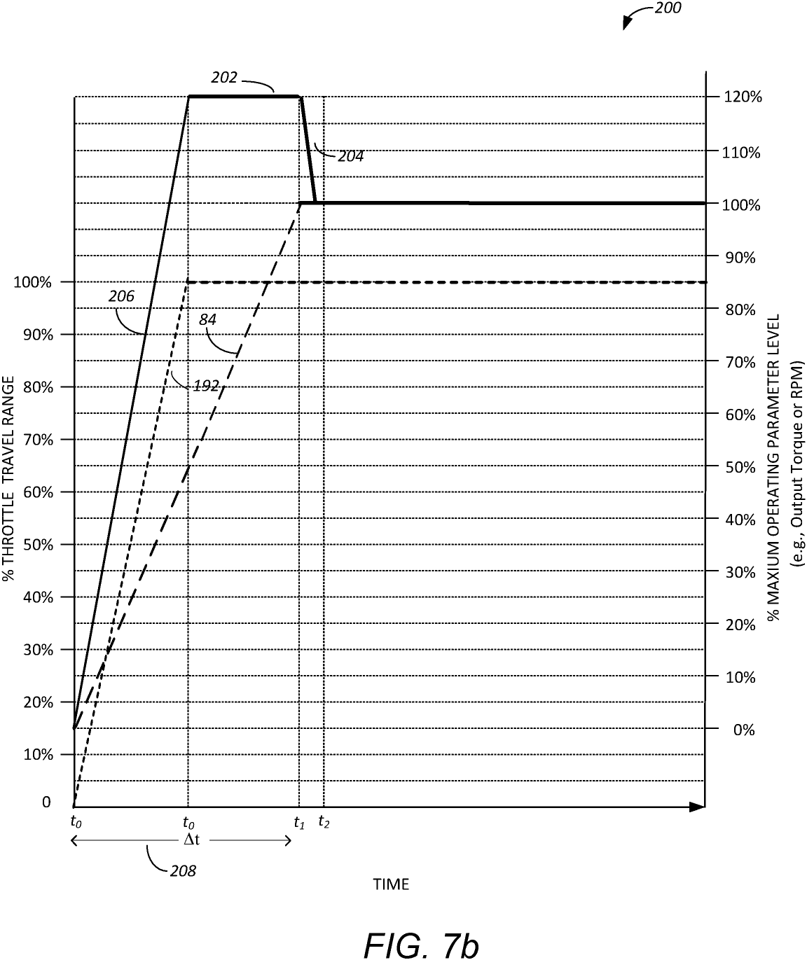

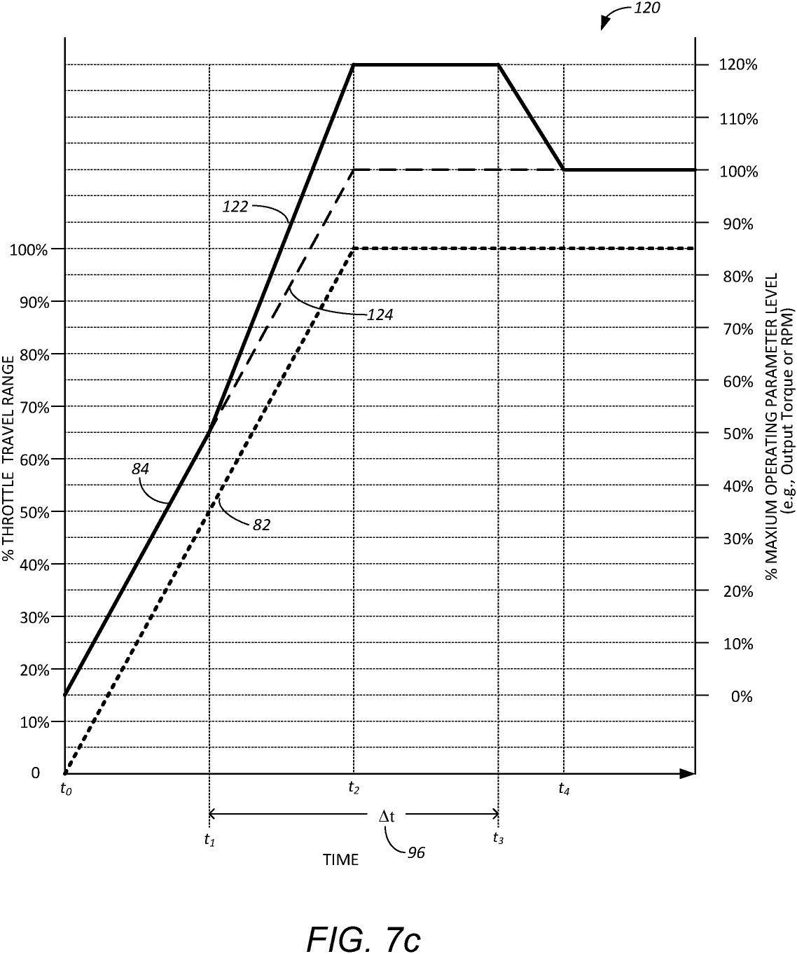

As mentioned above, in some examples, the boost operating mode may be initiated before motor 28 starts providing power, or when motor 28 is operating at less than the maximum operating level (see FIGS. 7a, 7b, for example) such that the increased operational power level causes a rate of change of the selected operating parameter to ramp-up at a faster rate to achieve a maximum operating parameter level or a boosted operating power level, more quickly than in a normal operating mode. In other words, the acceleration or responsiveness of the electric snowmobile 10 (or other electric vehicle) is increased, such that the electric snowmobile 10 permits an operator to cause electric motor 28 to go, for example, from zero torque or rotational speed to a maximum torque or rotational speed within a reduced amount of time. The rate at which a value of the selected operating parameter increases in response to actuation of throttle 42 is greater in boost operating mode than in normal operating mode. In other words, the mapping of the requested operating parameter is adjusted from the normal or base mapping (the first mapping) to the boost mapping (the second mapping), which in this example is a steeper mapping with throttle position than the first mapping.

In examples, a boost operating mode extends for a limited time period with the boosted operating power level of motor 28 available for such limited time period (also referred to as a “boost duration”). In some examples, the limited time period is a predefined fixed time period (e.g., 10 seconds, 15 seconds, etc.). In some examples, the limited time period may be terminated prior to expiration of the predefined fixed time period upon one or more operating parameter thresholds of the electric powertrain being exceeded (e.g., a maximum operating temperature or minimum operating voltage level of battery pack 22 being exceeded). In some examples, the limited time period may expire after the earlier of a preset fixed time has elapsed, a pre-defined vehicle speed has been reached or an operating parameter threshold of the electric powertrain has been exceeded.

In some examples, rather than having a predefined fixed time period, the limited time period expires after a predefined boost energy budget has been expended. For example, the boost duration may be variable and last as long as it takes an operator to consume the predefined boost energy budget. In examples, the predefined boost energy budget is an amount of energy consumed by electric motor 28 while operating at a boosted operating power level exceeding the maximum continuous operating power level or while operating at a boosted operating power level wherein the requested operating parameter is mapped to throttle position according to a second or boost mapping.

In some examples, a preset amount of time must expire between consecutive boost operations (sometimes referred to as a boost delay). For example, upon expiration of a boost duration of a first power boost operation, a boost delay period must expire before boost actuator 44 may again be actuated by an operator to initiate a next power boost operation. Such boost delay period is to enable temperatures of battery pack 22 and/or motor 28 to cool after completion of one boost operation before initiation of a next boost operation. Such a boost delay period may be any suitable time period (e.g., 10 seconds, 15 second, 60 seconds, etc.) In other examples, operating parameters permitting (e.g., temperatures and voltage levels of battery pack 22 and motor 28 do not exceed threshold levels), a predetermined number of power boost operations may be carried out in a given time period (e.g., three power boost operations within a 10 minute sliding window of time). It is noted that any number of scenarios may be implemented with regard to a frequency and duration of power boost operations.

FIG. 4 is a graph 90 illustrating the operation of power boost system 12, according to one example, and illustrates a mapping between a selected operating parameter level at which to operate motor 28 in response to a position of throttle 42 over a range of travel (e.g., a throttle lever moveable over a range, a throttle handle rotatable over a range of travel) during normal operation and in response to a power boost operation initiated by an operator via actuation of boost actuator 44. FIG. 4 may represent an example of the operation of power boost system 12 where the boosted operating power level may be activated and applied only when motor 28 is operating at the maximum operating level and throttle 42 is in a fully actuated position (i.e., 100% of travel range).

At time t₀, throttle 42 is at 0% of its travel range such that selected operating parameter of motor 28 is at a “zero” value (e.g., “zero” output torque and/or “zero” rotational speed). Between time t₀ and t₁, an operator actuates throttle 42 from 0% to 100% of its travel range such that motor 28 is operating at 100% of the maximum operating parameter value at time t₁. In FIG. 4, it is assumed that a permitted ramp rate will facilitate a real-time correspondence between the throttle position (curve 82) and an associated level of operating parameter (curve 84) achievable by the motor 28. From time t₁ to time t₂, throttle 42 is maintained at 100% of its travel range during time which motor 28 is operating at 100% of the maximum parameter operating level (e.g., maximum output torque or rotational speed). It is noted that power boost system 12 is operating in normal operating mode from time t₀ and t₂, with the corresponding portion of curve 84 represents a first or normal mapping of throttle position to the selected operating parameter level.

At time t₂, boost actuator 44 is actuated to initiate a boost operating mode whereby the maximum operating power available to motor 28 is increased from the maximum operating power level (e.g., the predefined maximum operating power level or the maximum continuous operating power level) to a maximum boosted operating power level. As illustrated, beginning at time t₂, based on the increased operating power level available to electric motor 28, the mapping of the level of the selected operating parameter to throttle position ramps up (is increased), as indicated at 92, from 100% of the maximum operating parameter level to a maximum boosted operating parameter level which, in this example, is 120% of the maximum operating parameter level. It is noted that a duration of such ramp-up time may be any suitable duration to enable a smooth transition to the boosted operating power level. As described above, the maximum boosted operating parameter level represents the operating parameter level at which electric motor 28 operates at a power level equal to the maximum boosted operating power level. In one example, the maximum operating parameter value during normal operating mode (i.e., represented as 100% of the maximum operating parameter value in FIG. 4) represents the operating parameter level at which electric motor 28 operates at a power level equal to the maximum continuous operating power level. While the boosted operating power level is illustrated in FIG. 4 as providing a 20% increase of the maximum operating parameter level of motor 28 (e.g., output torque or rotational speed), in other examples, the maximum boosted power level may provide increases of greater than or less than 20%.

In the example of FIG. 4, from time t₂ to time t₃, with power boost system 12 in boost operating mode, throttle 42 is maintained at 100% of its travel range with motor 28 operated with a boosted operating parameter level of 120% of the maximum operating parameter level. A level of the selected operating parameter at which motor 28 would be operating in the absence of the boosted operating power level is illustrated by the dashed line from time t₂ to time t₃. At time t₃, a boost duration 96 (Δt) of the boost operation initiated at time t₂ expires, and with a position of throttle 42 maintained 100% of its travel range, the maximum operating power level available to motor 28 is decreased by power boost system 12 from the maximum boosted operating power level to the maximum operating power level, and the operating parameter level is ramped down from 120% of the maximum operating parameter level to 100% of the maximum operating parameter level, as indicated at 98. In FIG. 4, with respect to curve 84 representing a mapping of the selected operating parameter level to throttle position, the solid line from time t₀ to time t₂, the dashed line 94, and the solid line following time t4 represent a first or normal mapping, while the solid lines from time t₂ to time t₄ represents a second or boost mapping.

FIG. 5 is a graph 100 illustrating the operation of boost power system 12, according to one example, and illustrates a mapping between a position of throttle 42 over a range of travel and a selected operating parameter level of electric motor 28 (e.g., output torque or rotational speed) in both a normal operating mode and a boost operating mode initiated by operator actuation of boost actuator 44. FIG. 5 represents an example where the power boost operation is activated when electric motor 28 is operating at a power level less than the maximum operating level with throttle 42 at less than a fully actuated position (i.e., less than 100% of the travel range). At time t₀, throttle 42 is at 0% of its travel range such that the selected operating parameter of motor 28 is at a “zero” value (e.g., “zero” output torque and/or “zero” rotational speed). Between time t₀ and t₁, an operator actuates throttle 42 from 0% to 80% of its travel range such that motor 28 is operating at 80% of the maximum operating level (e.g., maximum output torque or allowed rotational speed) at time t₁. At time t₁, a power boost operation is initiated by actuation of boost actuator 44. From time t₁ to time t₂, the position of throttle 42 is further actuated from 80% to 85% of the throttle travel range such that a boosted level of the selected operating parameter is gradually applied (ramped up), as indicated at 102, until at time t₂ the level of the selected operating parameter at which electric motor 28 is being driven is 20% greater than the selected operating parameter level at which motor 28 would be operating in the absence of the boost operation (as indicated by the dashed curve at 104).

As illustrated by the example of FIG. 5, a mapping of the level of the selected operating parameter to the position of throttle 42 is adjusted from a first mapping (a normal mapping) to a second mapping (a boost mapping). Specifically, a greater value of the selected operating parameter is mapped to a given position of throttle 42 during the boost operation than during normal operation. In examples, operating parameter values of the second mapping (boost mapping) may be increased relative to operating parameter values of the first mapping (normal mapping) by a fixed amount, or by a percentage of the normal mapping values or the maximum operating parameter value). In order to operate electric motor 28 at the increased operating parameter values (e.g., increased output torque or rotational speed), controller 40 operates electric motor 28 at an increased power level where, during a boost operation, electric motor 28 is enabled to operate at power levels above the predefined maximum operating power level or the maximum continuous operating power level.

From time t₂ to time t₃, the position of throttle 42 increases from 85% to 100% of the throttle travel range such that at time t₃, the level of the selected operating parameter of motor 28 is at the maximum boosted operating power level of 120% of the maximum operating level. In FIG. 5, it is assumed that a permitted ramp rate will facilitate a real-time correspondence between the throttle position (curve 82) and an associated level of operating parameter (curve 84) achievable by the motor 28. In order to operate electric motor 28 at the increased operating parameter values (e.g., increased output torque or rotational speed), controller 40 operates electric motor 28 at an increased power level where, during a boost operation, electric motor 28 is enabled to operate at power levels above a predefined maximum operating power level, which may be above the maximum continuous operating power level.

From time t₃ to time t₄, the position of throttle 42 is maintained at 100% of the throttle travel range such that the level of the selected operating parameter of motor 28 is maintained at the maximum boosted operating level of 120% maximum operating level when in normal operating mode. At time t₄, the boost duration 96 expires while throttle 42 is maintained at 100% of the throttle travel range such that the level of the selected operating parameter of motor 28 transitions from the boosted operating level (120%) to the maximum operating level (100%) in normal operating mode, as indicated at 106

FIG. 6 is a graph 110 illustrating another example of the operation of boost power system 12 where a power boost operation is initiated when electric motor 28 is operating at a power level less than a maximum operating level with throttle 42 at less than a fully actuated position (i.e., less than 100% of the travel range).. At time t₀, throttle 42 is at 0% of its travel range, such that the selected operating parameter of motor 28 is at a “zero” value (e.g., “zero” output torque and/or “zero” rotational speed). Between time t₀ and t₁, an operator actuates throttle 42 from 0% to 60% of its travel range such that motor 28 is operating at 60% of the maximum operating level (e.g., maximum output torque or allowed rotational speed) at time t₁. In FIG. 6, it is assumed that a permitted ramp rate will facilitate a real-time correspondence between the throttle position (curve 82) and an associated level of operating parameter (curve 84) achievable by the motor 28. Between time t1 and t2, throttle 42 is maintained at 60% of its travel range such that the level of the selected operating parameter of motor 28 is maintained at a level of 60% of the maximum operating level. At time t₂, a power boost operation is initiated by actuation of boost actuator 44. With throttle 42 maintained at 60% of the travel range, the level of the selected operating parameter of motor 28 is gradually boosted and, as indicated at 112, transitions from 60% to 80% of the maximum operating level (i.e., 80% of maximum torque or rotational speed in normal operating mode). In such case, a mapping of the level of the selected operating parameter (e.g., output torque or rotational speed) to the position of throttle 42 is adjusted from a first mapping (normal mapping) to a second mapping (boost mapping). Specifically, a greater value of the selected operating parameter is mapped to a given position of throttle 42 during the boost operation mode than during normal operation mode. In examples, operating parameter values of the second mapping (boost mapping) may be increased relative to operating parameter values of the first mapping (normal mapping) by a fixed amount, or by a percentage of the normal mapping values or the maximum operating parameter value).

From time t2 to time t3, throttle 42 is maintained at 60% of the travel range and, due to the boosted power level, motor 28 is operated at 80% of the maximum operating parameter level (i.e., at 80% of maximum output torque or rotational speed when operating in normal mode). In order to operate electric motor 28 at increased operating parameter levels (e.g., increased output torque or rotational speed) during a power boost operation (initiated in response to a power boost command from boost actuator 44), controller 40 operates electric motor 28 at an increased power level relative to the normal operating mode, where during a boost operation, electric motor 28 is enabled to operate at power levels above the maximum continuous operating power level of electric motor 28.

From time t3 to time t₄, while still within the window of boost duration 96, a position of throttle 42 is reduced from 60% to approximately 55% of the travel range, with the level of the selected operating parameter of motor 28 (e.g., output torque or rotational speed) being reduced correspondingly from 80% to approximately 75% of the maximum operating level. At time t₄, boost duration 96 expires, and after time t₄, as the position of throttle 42 continues to be reduced, the level of the selected operating parameter of motor 28 transitions or ramps-down (as indicated at 114) from the boosted operating level to a non-boosted operating level at time t₅. A level of the selected operating parameter of motor 28 in the absence of the boost operation initiated at time t3 is indicated by the dashed line at 116.

FIG. 7a is a graph 190 illustrating the operation of power boost system 12, according to one example, where the power boost system 12 acts as a type of launch control to increase available power for a vehicle that is starting from a resting position. The boost operating mode is actuated prior to motor 28 providing motive energy, when the throttle 42 is in a fully de-actuated position (i.e. 0% of travel range). In one example, the boost operating mode may only be actuated when the throttle 42 is in a de-actuated position (e.g. when the vehicle is at rest), such that the controller 42 will only act upon an input from boost actuator 44 when the throttle 42 is in the de-actuated position. In another example, the boost operating mode may be actuated at any time during vehicle operation.

As previously described, a mapping exits between a position of throttle 42 and a requested level of the operating parameter at which to control motor 28 (e.g. Nm or rpm). However, depending on the permitted ramp rate, the rate of change of the operating parameter (e.g. Nm/ms, rpm/ms) may create a situation where at a given time period, the level of operating parameter achieved be the motor 28 lags the requested level of the operating parameter associated with the throttle 42 position. In one example, the actuation of the boost actuator 44 causes the ramp rate at which the motor 28 is able to achieve a requested level of operating parameter to be faster than in the normal mode of operation.

In FIG. 7a, throttle position as a percentage of the actuation range is illustrated by curve 192. In response to the throttle position, curve 84 shows a level of the requested operating parameter achievable by the electric motor 28 in the normal operating mode, where the controller 40 controls the rate of change of the operating parameter according to a first ramp rate. As shown, it takes longer for the motor 28 to achieve 100% of the maximum value of the operating parameter (from to to t₁) than it takes an operator to actuate the throttle 42 to the 100% actuated position (from t₀ to t_{0.5}). Curve 194 shows a level of the requested operating parameter achievable by the electric motor 28 in response to the throttle position in the boost operating mode. In the boost operating mode, the controller 40 controls the rate of change of the operating parameter according to a second ramp rate. The second ramp rate in the boost operating mode is higher than the first ramp rate in the normal operating mode. As such, with the faster ramp rate in the boost operating mode, the electric motor 28 is able to achieve 100% of the maximum value of the operating parameter in the same time it takes an operator to actuate the throttle 42 to the 100% actuated position. If the ramp rate is faster, the vehicle accelerates more quickly and is felt to be more responsive to an operator.

At time t₀, throttle 42 is at 0% of its travel range such that selected operating parameter of motor 28 is at a “zero” value (e.g., “zero” output torque and/or “zero” rotational speed). Prior to time t₀, an operator actuates the boost actuator 44 so that when throttle 42 is actuated, the motor 28 is controlled according to the boost operating mode which has a higher ramp rate (rate of change of the commanded operating parameter level) than in the normal operating mode. Between time to and t_{0.5}, an operator actuates throttle 42 from 0% to 100% of its travel range such that motor 28 is requested to operate at 100% of the maximum operating parameter value, which may correspond to a maximum continuous operating power level or a predefined maximum continuous operating power level. In the boost operating mode, the ramp rate is such that the motor 28 is enabled to operate at 100% of the maximum operating parameter value by time t_{0.5}. In the normal operating mode, the ramp rate is such that the motor 28 is only able to achieve 100% of the maximum operating parameter value by time t₁.

In this example, in the boost operating mode, the motor 28 is able to achieve the maximum operating parameter level, and thus the maximum operating power, more quickly than in the normal operating mode.

In the example of FIG. 7a, the boost operating mode lasts for a boost duration 196 (Δt). In some examples, the boost duration 196 is of a limited time period that may terminate when the motor 28 achieves 100% of the maximum operating parameter (i.e. when the vehicle is operating at the maximum continuous operating power level). In some examples, the limited time period may terminate once a predefined time period has elapsed. In other examples, the limited time period may terminate once a predefined vehicle speed has been attained. In other examples, the limited time period may terminate once a predefined boost energy budget has been exhausted. In other examples, the limited time period may expire after the earlier of a preset fixed time has elapsed, a pre-defined vehicle speed has been reached or an operating parameter threshold of the electric powertrain has been exceeded.

FIG. 7b is a graph 200 illustrating the operation of power boost system 12, according to another example, where the power boost system 12 also acts as a type of launch control in a similar fashion to that shown in FIG. 7a. However, in FIG. 7b, in the boost operating mode, the system 12 ramps up to a maximum boost power level instead of a predefined maximum operating power level or a maximum continuous operating power level. The boost operating mode is actuated prior to motor 28 providing motive energy, when the throttle 42 is in a fully de-actuated position (i.e. 0% of travel range).

In FIG. 7b, throttle position as a percentage of the actuation range is illustrated by curve 192 and curve 84 shows a level of the requested operating parameter achievable by the electric motor 28 in the normal operating mode, where the controller 40 controls the rate of change of the operating parameter according to a first ramp rate. As shown, it takes longer for the motor 28 to achieve 100% of the maximum value of the operating parameter (from t₀ to t₁) than it takes an operator to actuate the throttle 42 to the 100% actuated position (from t₀ to t_{0.5}). Curve 206 shows a level of the requested operating parameter achievable by the electric motor 28 in response to the throttle position in the boost operating mode where the controller 40 controls the rate of change of the operating parameter according to a second ramp rate. The second ramp rate in the boost operating mode is higher than the first ramp rate in the normal operating mode. As such, with the faster ramp rate in the boost operating mode, the electric motor 28 is able to achieve 120% of the maximum value of the operating parameter in the same time it takes an operator to actuate the throttle 42 to the 100% actuated position.

At time t₀, throttle 42 is at 0% of its travel range such that selected operating parameter of motor 28 is at a “zero” value (e.g., “zero” output torque and/or “zero” rotational speed). Prior to time t₀, an operator actuates the boost actuator 44 so that when throttle 42 is actuated, the motor 28 is controlled according to the boost operating mode which has a higher ramp rate (rate of change of the commanded operating parameter level) than in the normal operating mode. Between time to and t_{0.5}, an operator actuates throttle 42 from 0% to 100% of its travel range. Since the boost actuator 44 was actuated prior to actuation of the throttle 42, the maximum operating power available to motor 28 is increased from the predefined maximum operating power level (which may be the maximum continuous operating power level) to a maximum boosted operating power level. The boosted operating power level may be a percentage increase of the predefined maximum operating power level. Based on the increased operating power level available to electric motor 28, both the ramp rate and the mapping of the level of the selected operating parameter to throttle position ramps up (is increased), as indicated by curve 206, from 100% of the maximum operating parameter level to a maximum boosted operating parameter level which, in this example, is 120% of the maximum operating parameter level. In the boost operating mode, the ramp rate and throttle mapping is such that the motor 28 is enabled to operate at 120% of the maximum operating parameter value by time t_{0.5}. In the normal operating mode, the ramp rate is such that the motor 28 is only able to achieve 100% of the maximum operating parameter value by time t₁.

In the example of FIG. 7b, the boost operating mode lasts for a boost duration 206 (Δt), between t₀ and t₁. From t₀ and t_{0.5} the position of throttle 42 increases from 0% to 100% of the throttle travel range, and the selected operating parameter of motor 28 ramps up from 0 to the maximum boosted operating power level of 120% of the maximum operating level. From time t_{0.5} to time t₁, the position of throttle 42 is maintained at 100% of the throttle travel range and the selected operating parameter of the motor 28 is maintained at the maximum boosted operating level of 120% of the maximum operating level when in normal operating mode. At time t₁, the boost duration 208 expires while throttle 42 is maintained at 100% of the throttle travel range such that the level of the selected operating parameter of motor 28 transitions from the boosted operating level (120%) to the maximum operating level (100%) in normal operating mode, as shown at 204, between time t₁ to t₂.

In some examples, the boost duration 196 is of a limited time period that may terminate once a predefined time period has elapsed. In other examples, the limited time period may terminate once a predefined vehicle speed has been attained. In other examples, the limited time period may terminate once a predefined boost energy budget has been exhausted. In other examples, the limited time period may expire after the earlier of a predefined fixed time has elapsed, a pre-defined vehicle speed has been reached or an operating parameter threshold of the electric powertrain has been exceeded.

In both the examples of FIGS. 7a and 7b, it is to be understood that the specific ramp rates for the normal operating mode and boost operating mode may vary depending on whether the vehicle is operating in an Eco, Normal or Sport mode. The ramp rates for the normal operating mode and the boost operating mode will be lower in the Eco mode than in the Sport mode.

FIG. 7c is a graph 120 illustrating the operation of power boost system 12, according to one example, and illustrates a mapping between a position of throttle 42 over a range to travel (as illustrated by curve 82) and a selected operating parameter level (as illustrated by curve 84) at which electric motor 28 will be driven (e.g., output torque or rotational speed), such as by controller 40, in both a normal operating mode (curve 124) and a boost operating mode (curve 122) initiated by operator actuation of boost actuator 44. From time t₀ to time t₁, electric motor 28 is operated in a normal operating mode. At time t₀, throttle 42 is at 0% of its travel range such that the selected operating parameter of motor 28 is at a “zero” value (e.g., “zero” output torque and/or “zero” rotational speed). Between time t₀ and t₁, an operator actuates throttle 42 from 0% to 50% of its travel range such that motor 28 is operating at 50% of the maximum operating parameter level (e.g., maximum output torque or allowed rotational speed) at time t₁. FIG. 7c assumes that a permitted ramp rate will enable a real-time correspondence between the throttle 42 position and the associated level of operating parameter achieved by the motor 28.

At time t₁, a power boost operation is initiated by actuation of boost actuator 44. From time t₁ to time t₂, the position of throttle 42 is further actuated from 50% to 100% of the throttle travel range. During the boost operation, the selected operating parameter level at which electric motor 28 is driven switches from a first mapping having a first rate of increase to a second mapping having a second rate of increase (which is greater than the first rate of increase), such that the boosted level of the selected operating parameter follows the second mapping (having the second rate of increase), as indicated at 122, as opposed to continuing to follow the first mapping having the first rate of increase in the absence of a boost operation, as indicated by the dashed line at 124. As a result, when the throttle reaches 100% of its travel range at time t₂, the operating parameter level is mapped via the second mapping to the maximum boosted operating parameter level of 120% of the maximum operating parameter level rather than to only 100% of the maximum operating parameter level according to the first mapping in the absence of a power boost operation. Alternatively, or additionally, during the boost operation, a steeper rate of increase of the selected operating parameter may also be achieved by switching from a first ramp rate to a faster, second ramp rate. In one example, by making a maximum boosted power level available to the motor when in the boosted operating mode, the motor 28 may ramp up to the maximum boosted operating parameter level in the same amount of time it would normally take the motor 28 to ramp up to the maximum operating parameter level in the normal mode of operation, such that the permitted rate of change of the operating parameter is faster in the boosted operating mode than in the normal operating mode.

From time t₂ to time t₃, throttle 42 is maintained at 100% of its travel range such that the operating parameter level at which electric motor 28 is driven is maintained at the maximum boosted level of 120% of the maximum continuous operating parameter level. At time t3, the boost duration 96 expires. From time t3 to time t4, throttle 42 is maintained at 100% of its travel range and, due to the expiration of boost duration 96, the operating parameter level at which electric motor 28 is driven ramps back to down the first mapping and to a level of 100% of the maximum operating parameter level. After time t4, throttle 42 is maintained at 100% of its travel range and the operating parameter level at which electric motor 28 is driven follows the first mapping at a level of 100% of the maximum operating parameter level.

In some examples, rather than being implemented as separate devices, accelerator (throttle) 42 and boost actuator 44 may be implemented within a single device. In one example, throttle 42 and boost actuator 44 may be implemented by a single actuator which may be actuated by an operator over a range of travel, wherein a first portion of the range of travel represents throttle 42, and a second portion of the range of travel, following the first portion, represents boost actuator 44.

FIG. 8 is a graph 130 illustrating an example of an operation of a single actuator implementing both throttle 42 and boost actuator 44, referred to herein as combined actuator 42/44. In one example, the combined actuator 42/44 may be operator-actuated over a range of travel, as indicated on the X-axis, with a first portion 132 of the range corresponding to throttle 42 and a second portion 134 of the range of travel, following the first portion 132, corresponding to boost actuator 44. The Y-axis on the right side of graph 130 represents a percentage of the maximum operating parameter level at which motor 28 operates based on the position of combined actuator 42/44 over the range of travel.

Curve 136 represents a mapping between an operating parameter level (e.g., output torque or rotational speed) at which motor 28 is driven to operate relative to a position of the combined actuator 42/44 within the range of travel. According to one example, as illustrated, the relationship is linear, with approximately the first 85% of the range of travel corresponding to a non-boosted operating parameter level of motor 28 (from 0 up to 100%of the maximum operating parameter level, and approximately a final 15% of the range corresponding to a boosted operating parameter level (from 100% to 120% of the maximum operating parameter level). As described above, operating electric motor 28 at with a selected operating parameter (e.g., output torque) having the maximum operating parameter level may result in electric motor operating at the maximum continuous operating power level).

In one example, as illustrated, combined actuator 42/44 may be implemented as variable resistance actuator having a variable actuation resistance over the range of travel. In FIG. 8, an actuation resistance of combined actuator 42/44 is illustrated by a Y-axis on the left side of graph 130, with a level of resistance increasing vertically along the axis, and a curve 138 represents a mapping of an actuation resistance of combined actuator 42/44 over a range of travel. In one example, combined actuator 42/44 may be a lever moveable over a range and having a first actuation resistance over the first portion 132 of the range of throttle travel, and a second actuation resistance over the second portion 134 of the range of throttle travel, wherein the second actuation resistance is greater than the first actuation resistance. In one example, as illustrated, an actuation resistance of combined actuator 42/44 may be at a constant level over the first portion 132 of the range of travel, as indicated by a horizontal portion 142 of curve 138, and may jump to a greater and non-linear resistance value over the second portion 134 of the range of travel, as indicated by the portion 144 of curve 138. In examples, combined actuator 42/44 may be a haptic actuator having an actuation resistance controllable by controller 40 over the range of motion (e.g., an electrically controllable magnetic field to create a variable actuation resistance). According to the example of FIG. 8, actuation resistance of combined actuator 42/44 corresponding to second portion 134 is greater than the actuation resistance corresponding to the first portion 132 of the range of travel to ensure that an operator does not inadvertently provide an unintended boosted operating power level to motor 28. In one example, as illustrated, an actuation resistance of combined actuator 42/44 continues to increase over second portion 134 such that an operator must exert an increasingly greater force to attain the maximum boosted power level which, in the illustrated example, is 120% of the predefined maximum operating power level, which may be the maximum continuous operating power level.

It is noted that the example of FIG. 8 is for illustrative purposes, and that any number of arrangements may be employed to implement a combined actuator 42/44, including any number of arrangements (including haptic implementations) to implement a variable resistance actuator. For example, in one case, at the transition between first portion 132 and second portion 134, there is a resistance spike 128 that must be overcome, but once overcome, the resistance decreases such that the actuation resistance over the second portion 134 is at the same level 142 as over the first portion 122. Any number of different arrangements may be employed to implement a combined actuator 42/44.

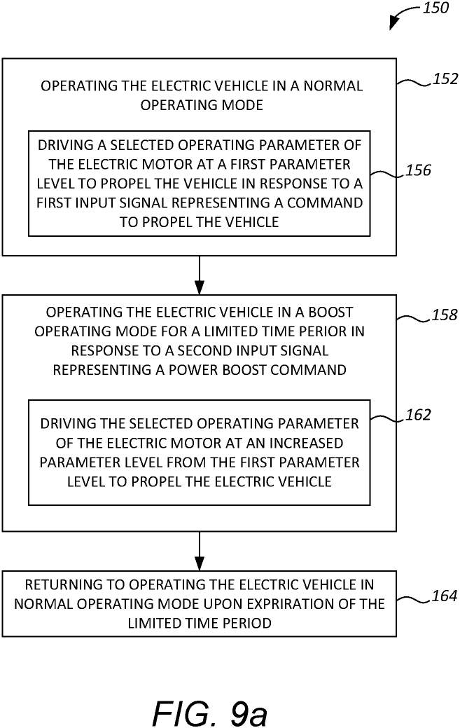

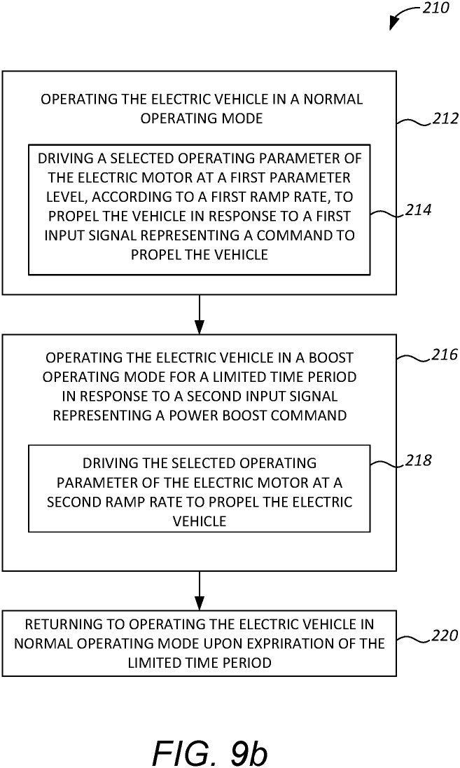

FIG. 9a is a flow diagram generally illustrating a method 150 of operating an electric vehicle, such as electric snowmobile 10, according to one example. In examples, machine readable instructions, such as power boost instructions 54 and vehicle operating instructions 58 may be executed, such as by processor 50 of controller 40 to perform at least portions of the method 150. Aspects of method 150 may be combined with other methods described herein, with aspects of electric snowmobile 10 being incorporated into method 150 and other methods described herein.

At 152, method 150 includes operating the electric vehicle in a normal operating mode, where such normal operating mode includes, at 156, driving a selected operating parameter of the electric motor at a first level to propel the vehicle in response to a first input signal representative of a command to propel the electric vehicle, such as controller 40 receiving a command to propel electric snowmobile from a first input represented by accelerator 42 having the form of a throttle position (actuator position) moveable over an actuation range (such as illustrated by FIGS. 1A, 2, and 3, for example) and driving a selected operating parameter of motor 28 (e.g., an output torque or rotational speed) at a percentage of a maximum parameter level in response to the throttle position, in accordance with a first or normal mapping (such as illustrated by FIG. 3, for example). In examples, the throttle position may vary dynamically over time such that the level at which the selected operating parameter is driven is time-varying. In one example, at 152, the normal operating mode includes providing up to a first power level to an electric motor of the electric vehicle, such as controller 40 operating electric snowmobile 10 in a normal operating mode including providing up to a first power level to electric motor 28 which is up to a maximum continuous operating power level of electric motor 28.

Method 150, at 158, includes operating the electric vehicle in a boost operating mode for a limited time period in response to a second input signal representative of a power boost command, such as controller 40 receiving a power boost command from boost actuator 44 (see FIGS. 1A, 2, and 4-7c, for example) to initiate a power boost operation. At 162, the boost operating mode 158 includes driving the selected operating parameter of the electric motor at an increased level from the first level to propel the electric vehicle, such as controller 40 driving the selected operating parameter of electric motor 28 (e.g., an output torque or rotational speed) at a boosted parameter level in response to the position of throttle 42, in accordance with a second or boosted mapping (such as illustrated by FIGS. 4-6 and 7c, for example). In one example, at 158, the boost operating mode includes providing up to a second power level to the electric motor, the second power level greater than the first power level, such as controller 40, in response to receiving the power boost command from boost actuator 44, controller 40 controlling electric powertrain 20 (such as via execution of power boost instructions 54) to drive electric motor 28 at a boosted power level. In examples, the boost power level is a predetermined amount of additional power (e.g., included as part of power boost instructions 54). In examples, the boosted power level is a percentage of the maximum continuous operating power level of electric motor 28 (e.g., 110%, 120%, ..., 150% of the maximum continuous operating power level).

At 164, method 150 includes returning to operating the electrical vehicle in the normal operating mode upon expiration of the limited time period (or boost duration), such as controller 40 returning electric snowmobile 10 to a normal operating mode upon expiration of a power boost operation initiated by actuation of boost actuator 44 (e.g., a push-button). In one example, the limited time period is a predefined fixed time duration stored as a threshold value 56 (e.g., see FIG. 2). In one example, the limited time period expires after the predefined fixed time duration elapses. In one example, the limited time period may expire prior to the predefined fixed time duration expiring if one or more operating parameters of electric powertrain 20 are exceeded, such as a temperature level, voltage level, or current level of battery pack 22 being exceeded, or a current level, temperature level of electric motor 28 being exceeded (where such levels may be stored as threshold values 56). In one example, the limited time period may expire after a predefined boost energy budget has been exhausted. For example, the boost operating power level may provide an additional amount of energy, such as 0.5 to 2.5 kWh (kilowatt-hours), wherein the limited time period may last for as long as it takes for the electric vehicle to consume the boost energy budget.

FIG. 9b is a flow diagram generally illustrating a method 200 of operating an electric vehicle, such as electric snowmobile 10, according to another example. In examples, machine readable instructions, such as power boost instructions 54 and vehicle operating instructions 58 may be executed, such as by processor 50 of controller 40 to perform at least portions of the method 200. Aspects of method 200 may be combined with other methods described herein, with aspects of electric snowmobile 10 being incorporated into method 200 and other methods described herein.

At 212, method 200 includes operating the electric vehicle in a normal operating mode, where such normal operating mode includes, at 214, driving a selected operating parameter of the electric motor at first level, and according to a first ramp rate, to propel the vehicle in response to a first input signal representative of a command to propel the electric vehicle. In one example, at 212, the normal operating mode includes providing up to a first power level to an electric motor of the electric vehicle, such as controller 40 operating electric snowmobile 10 in a normal operating mode including providing up to a first power level to electric motor 28 which may be up to a maximum continuous operating power level of electric motor 28.

Method 200, at 216, includes operating the electric vehicle in a boost operating mode for a limited time period in response to a second input signal representative of a power boost command, such as controller 40 receiving a power boost command from boost actuator 44 to initiate a power boost operation. At 218, the boost operating mode 158 includes driving the selected operating parameter of the electric motor 28 at a second ramp rate in response to a position of accelerator 42, the second ramp rate being an increased ramp rate from the first ramp rate. In one example, at 218, the boost operating mode includes providing up to a second power level to the electric motor 28, the second power level being greater than the first power level, such that controller 40, in response to receiving the power boost command from boost actuator 44, controls electric powertrain 20 (such as via execution of power boost instructions 54) to drive electric motor 28 at an increased ramp rate based on a position of accelerator 42 up to a boosted power level, that may exceed the maximum continuous operating power level. In examples, the boost power level is a predetermined amount of additional power (e.g., included as part of power boost instructions 54). In examples, the boosted power level is a percentage of the predefined maximum operating power level of electric motor 28 (e.g., 110%, 120%, ..., 150% of the maximum continuous operating power level).

At 220, method 200 includes returning to operating the electrical vehicle in the normal operating mode upon expiration of the limited time period (or boost duration), such as controller 40 returning electric snowmobile 10 to a normal operating mode upon expiration of a power boost operation initiated by actuation of boost actuator 44 (e.g., a push-button). In one example, the limited time period is a predefined fixed time duration stored as a threshold value 56 (e.g., see FIG. 2). In one example, the limited time period expires after the predefined fixed time duration elapses. In one example, the limited time period may expire prior to the predefined fixed time duration expiring if one or more operating parameters of electric powertrain 20 are exceeded, such as a temperature level, voltage level, or current level of battery pack 22 being exceeded, or a current level, temperature level of electric motor 28 being exceeded (where such levels may be stored as threshold values 56). In one example, the limited time period may expire after a a predefined vehicle speed has been reached. In one example, the limited time period may expire after a predefined boost energy budget has been exhausted. For example, the boost operating power level may provide an additional amount of energy, such as 0.5 to 2.5 kWh (kilowatt-hours), wherein the limited time period may last for as long as it takes for the electric vehicle to consume the boost energy budget.

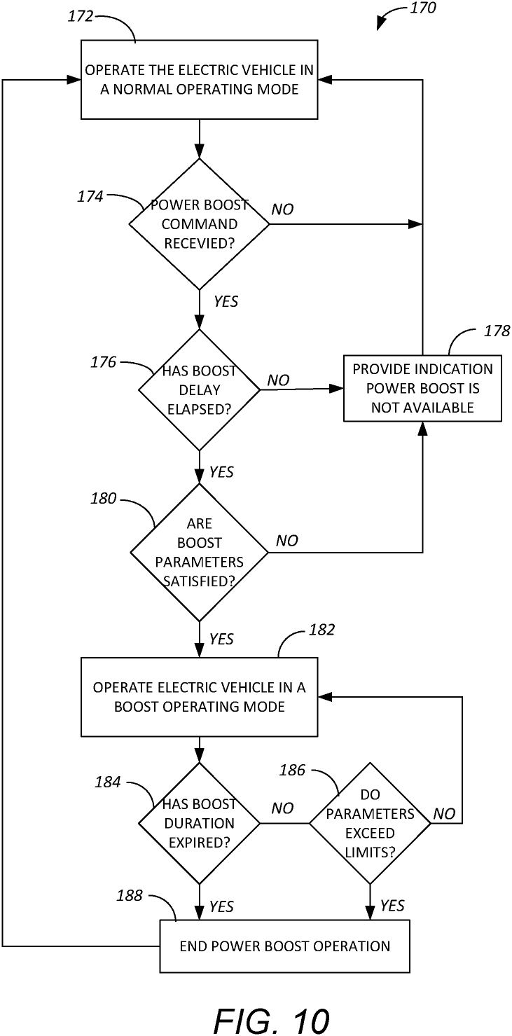

FIG. 10 is a flow diagram generally illustrating a method 170 of operating an electric vehicle, such as electric snowmobile 10, according to one example. Method 170 begins at 172 with operating the electric vehicle in a normal operating mode, including operating an electric motor of the electric vehicle at up to a first power level, and driving a selected operating parameter (e.g., output torque or rotational speed) of the electric motor at a first parameter level in response to a first input, such as controller 40 operating electric motor 28 at a power level up to a first power level represented by a maximum continuous operating power level of electric motor 28, and operating a selected operating parameter (e.g., output torque or rotational speed) at a parameter level corresponding to a first mapping (a normal mapping) between a position of moveable accelerator actuator 42 (e.g., throttle 42) within an actuator range and an operating parameter level (such as illustrated by FIG. 1A-3, for example). As described above, a maximum first parameter level in normal operating mode is an operating parameter level at which electric motor 28 operates at the maximum continuous operating power level. In examples, during normal operating mode, controller 40 limits the operating power level of motor 28 to the maximum continuous operating power level such as by controlling an amount of drive current provided by battery pack 22 to electric motor 28 or by controlling an amount of power provided to motor 28 by corresponding inverter 30.

At 174, method 170 queries whether a second input signal representative of a request to initiate a power boost operation has been received, such as controller 40 receiving a power boost command via actuation of boost actuator 44 by an operator (e.g., see FIGS. 1A and 2). If the answer to the query at 174 is “NO”, method 170 continues to operate electric motor 28 in accordance with normal operating mode at 172. If the answer to the query at 174 is “YES”, method 170 proceeds to 176.

At 176, method 170 queries whether a power boost delay time has elapsed since completion of a last power boost operation, such as power boost system 12, via execution of power boost instructions 54 by processor 50, querying whether a power boost time has elapsed, where such boost time delay may be maintained as a threshold value 56 (e.g., see FIG. 2). During a power boost operation, particularly if motor 28 is operated at power levels beyond the maximum continuous operating power level, components of electric powertrain 20, such as battery modules 24, inverter 30, and motor 28, may heat to temperatures higher than temperatures typically reached during operation at power levels at or below the maximum continuous operating power level. In examples, the boost delay time is a predetermined time delay between consecutive power boost operations during which components of electric powertrain 20 are expected to cool to temperature levels which enable a next power boost operation to be carried out without resulting in overheating of electric powertrain components.

If the answer to the query at 176 is “NO”, meaning that the power boost delay time has not elapsed, method 170 proceeds to 178 where indication is provided to an operator that a power boost operation in not currently available. In one example, such indication may be in the form of a visual indication, such as power boost system 12 providing indication to an operator via display 68 (e.g., see FIG. 2). Such indication may be provided in any number of suitable forms, such as in the form of a message provided on display 68 or in the form of a flashing indicator light (e.g., a flashing red indicator light), for example. It is noted that, in some examples, when a power boost operation is available to employed, power boost system 12 may provide indication to an operator, such as the in the form of a continuous green indicator light (as opposed to the same light being a flashing red light when a power boost operation is unavailable), for instance. Any type of suitable indication may be employed to inform an operator that a power boost operation is available.

If the answer to the query at 176 is “YES”, method 170 proceeds to 180. At 180, method 170 queries whether a number of power boost parameters are satisfied. Such power boost parameters may include whether battery pack 22 has a charge level sufficient to carry out a power boost operation, whether voltage, current, and temperature levels of battery pack 22 are within acceptable limits, and whether current, voltage, and temperature levels of electric motor 28 and inverter 30 are within acceptable limits, for example. It is noted that any number of parameters may be employed, and may be stored as threshold values 56 of power boost system 12. In some cases, for example, a power boost operation will be enabled only when motor 28 is operating at its maximum continuous operating power level. Thus, in some example, the power boost parameters include determining whether electric motor 28 is operating at its maximum continuous operating power level.

If the answer to the query at 180 is “NO”, meaning that at least one power boost parameter is not satisfied, method 170 proceeds to 178, where indication is provided to an operator that a power boost operation is presently unavailable. If the answer to the query at 180 is “YES”, meaning that all power boost parameters are at acceptable levels, method 170 proceeds to 182.

At 182, method 170 includes operating the electric vehicle, for a limited time period, in a boost operating mode. In examples, boost operating mode includes operating electric motor 28 up to a second power level (or boosted power level) which is greater than the first power level (e.g., exceeds the maximum continuous operating power level). In examples, boost operating mode further include driving the selected operating parameter of electric motor 28 at an increased, or boosted, parameter level (relative to the first parameter value) in response to the first input. In examples, the increased or boosted parameter level corresponds to a second mapping (a boost mapping) between a position of moveable throttle 42 within an actuator range and a level of the selected operating parameter (such as illustrated by FIG. 4, for example).

In some examples, the boosted operating power level is equal to a predefined percentage of the maximum continuous operating power level of electric motor 28 (e.g., 110%, 120%, ..., 150%). As an illustrative example, electric motor 28 may have a maximum continuous operating power level of up to 180 HP, where the maximum boost power level is a percentage of such maximum continuous operating power level, such as 110%, 120%, 130%, etc. In some examples, the maximum boost power level may be up to 150% of the maximum continuous operating power level of electric motor 28. As an illustrative example, in a case where the maximum continuous operating power level of electric motor 28 is 120 HP and where the maximum boosted operating power level is 50% of the maximum continuous operating power level, the maximum boosted operating power level of electric motor 28 is 180 HP.

In examples, during boost operating mode, power boost module 12 provides indication to controller 40 to operate motor 28 at an increased operating power level (boosted operating power level), which exceeds the maximum continuous operating power level of electric motor 28. In examples, during the duration of the boost operating mode, controller 40 limits the operating power level of motor 28 to a maximum boosted operating power level by controlling an amount of drive current provided by battery pack 22 to electric motor 28 or by controlling an amount of power provided to motor 28 by corresponding inverter 30, for example.

During boost operating mode, method 170 proceeds to 184, where it is queried whether a boost duration has expired. As described above, according to examples, boost power system 12 enables electric motor 28 to be operated at the boosted operating power level for a limited time, referred to herein as a “boost duration”. Such boost duration may be a predetermined fixed time period (e.g., 10 seconds, 15 seconds, etc.) maintained as threshold value 56 by boost power system 12. The boost duration, together with the boost delay (see 176 above), is intended to limit an amount of time at which motor 28 (and powertrain 20) may be operated at the booster operating power level so as to prevent potential thermal damage to components of electric powertrain 20. In some examples, the boost duration may expire after a pre-defined boost energy budget has been exhausted. For example, the boost operating power level may provide an additional amount of energy, such as 0.5 to 2.5 kWh (kilowatt-hours), wherein the boost duration may last for as long as it takes for the electric vehicle to consume the boost energy budget

If the answer to the query at 184 is “NO”, method 170 proceeds to 186, where it is queried whether any operating parameters of electric powertrain 20 have been exceeded. During a power boost mode of operation, power boost system 12 monitors operating parameters of electric powertrain 12, such as a charge level and temperature, voltage, and current levels of battery pack 22, for example, in order to prevent damage, including thermal damage, to components thereof. If the answer to the query at 186 is “NO”, meaning that none of the monitored operating parameters has exceeded allowable operating values (e.g., maintained as threshold values 56), method 170 continues operating motor 28 at the boosted operating power level.

If the answer to the query at either 184 or 186 is “YES”, meaning that either the boost duration has expired or that at least one monitored operating parameter has exceeded allowable limits, method 170 proceeds to 188 where the power boost operation initiated at 182 is terminated. In one example, method 170 then return to 172, where controller 40 returns to operating motor 28 at the first power level based on the first power level signal, such as provided by accelerator actuator 42. In examples, upon terminating a power boost operation, method 170, at 188, may provide indication (e.g., visual indication) to an operator that the power boost operation has ended (e.g., via visual and/or audio indication).

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An electric vehicle comprising:
an electric motor to propel the electric vehicle; and
a battery system to provide electrical power to the electric motor;
a first input device, when actuated, to provide a first input representing a command to propel the electric vehicle; and
a second input device, when actuated, to provide a second input representing a power boost command; and
a controller operative to control a permitted rate of change of a selected operating parameter of the electric motor to control propulsion of the electric vehicle, the controller to:
in a normal operating mode, operate the electric motor according to a first rate of change for the selected operating parameter in response to the first input; and
in a boost operating mode, operate the electric motor according to a second rate of change for the selected operating parameter for a limited period of time in response to the first input, the second rate of change being greater than the first rate of change, the boost operating mode initiated upon actuation of the second input device.

2. The electric vehicle of claim 1, wherein the first rate of change and the second rate of change are linear in relation to a range of positions of the first input.

3. The electric vehicle of claim 1, wherein at least the second rate of change is non-linear in relation to a range of positions of the first input.

4. The electric vehicle of claim 1, the selected operating parameter being one of an output torque and a rotational speed of the electric motor.

5. The electric vehicle of claim 1, wherein the controller controls a level of a selected operating parameter based on a mapping between the first input and a level of the selected operating parameter.

6. The electric vehicle of claim 1, the controller to:
in the normal operating mode, operate the electric motor up to a maximum continuous operating power level of the electric motor, wherein a maximum level of the selected operating parameter depends on the maximum continuous operating power level; and
in the boost operating mode, operate the electric motor up to a maximum boosted operating power level which is greater than the maximum continuous operating power level.

7. The electric vehicle of claim 5, wherein the boosted operating power level exceeds the maximum continuous operating power level by a percentage of the maximum continuous operating power level.

8. The electric vehicle of claim 1, upon expiration of the limited time period, the controller to return to operating the electric motor according to a first rate of change of the selected operating parameter in response to the first input.

9. The electric vehicle of claim 1, wherein the limited time period expires after a fixed time duration.

10. The electric vehicle of claim 1, wherein the limited time period expires upon a level of at least one monitored operating parameter of the motor and/or battery system satisfying expiration criteria.

11. The electric vehicle of claim 1, the controller capable of receiving the second input representing a power boost command only when the first input is in a de-actuated position.

12. The electric vehicle of claim 1, wherein the first input device comprises an accelerator actuator moveable over a range.

13. The electric vehicle of claim 1, the electric vehicle comprising an electric power sport vehicle.

14. A method of operating an electric vehicle, comprising:
operating the electric vehicle in a normal operating mode including:
receiving a first input representing a command to propel the electric vehicle; and
operating an electric motor according to a first rate of change for a selected operating parameter in response to the first input; and
operating the electric vehicle in a boost operating mode for a limited time period in response to receipt of a second input representing a power boost command, including:
operating the electric motor according to a second rate of change for the selected operating parameter in response to the first input, the second rate of change being greater than the first rate of change; and
returning to operating the electrical vehicle in the normal operating mode upon expiration of the limited time period.

15. The method of claim 14, comprising operating the electric vehicle in the boost operating mode only when the second input representing a power boost command is received when the first input is in a de-actuated position.

16. The method of claim 14, comprising operating the electric motor according to the first rate of change for the selected operating parameter based on a first mapping between the first input and a level of the selected operating parameter.

17. The method of claim 14, comprising determining expiration of the limited time period upon expiration of a fixed time duration.

18. The method of claim 14, comprising determining expiration of the limited time period upon a level of at least one monitored operating parameter of the electric motor and/or a battery system satisfying expiration criteria.

19. The method of claim 14, comprising operating the electric vehicle in the boost operating mode only after a time delay since expiration of a last limited time period and if levels of one or more monitored operating parameters of a battery system and/or the electric motor are within allowable ranges.

20. A method of operating an electric vehicle comprising:
receiving a first input representing a command to propel the electric vehicle;
driving a selected operating parameter of an electric motor of the electric vehicle at a first level based on the first input to propel the electric vehicle;
receiving a second input representing a power boost command;
in response to the second input, for a limited time period, driving the selected operating parameter at an increased level from the first level based on the first input.
